(19) United States
(12) Patent Application Publication
(10) Pub. No.: US 2009/0257776 A1
(43) Pub. Date: Oct. 15, 2009

(54) ELECTROPHOTOGRAPHIC PHOTORECEPTOR, IMAGE-FORMING APPARATUS, AND ELECTROPHOTOGRAPHIC CARTRIDGE

(75) Inventors: Teruyuki Mitsumori, Kanagawa (JP); Kozo Ishio, Kanagawa (JP); Hiroe Fuchigami, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Chemical Corporation, Minato-ku (JP)

(21) Appl. No.: 12/301,088

(22) PCT Filed: May 18, 2007
(86) PCT No.: PCT/JP07/60227

§ 371 Date: Nov. 17, 2008

(30) Foreign Application Priority Data
May 18, 2006 (JP) 2006-139530

(51) Int. Cl. G03G 15/00; G03G 5/04

(52) U.S. Cl. 399/159; 430/57.1

(57) ABSTRACT

Provided is an electrophotographic photoreceptor that is excellent in electric characteristics and can form a high-quality image having reduced ghosting. In the electrophotographic photoreceptor including an undercoat layer containing metal oxide particles and a binder resin on an electroconductive support, and a photosensitive layer disposed on the undercoat layer, the metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3; and the photosensitive layer contains a compound represented by the following Formula (I):

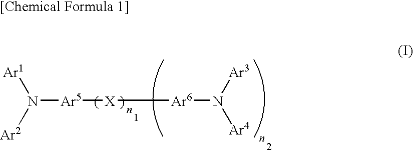

where Formula (I), Ar¹ to Ar⁶ each independently represent an aromatic moiety that may have a substituent; X represents an organic moiety that may have a substituent; and n₁ and n₂ each independently represent an integer of 0 to 2.

### TECHNICAL FIELD

The present invention relates to an electrophotographic photoreceptor having an undercoat layer, and an image-forming apparatus and an electrophotographic cartridge that include the photoreceptor.

### BACKGROUND ART

Recently, electrophotographic technology has been widely applied to the field of printers, as well as the field of copiers, due to its immediacy and formation of high-quality images. Electrophotographic photoreceptors (hereinafter, optionally, referred to as “photoreceptor”) lie in the core technology of electrophotography, and organic photoreceptors using organic photoconductive materials, having advantages such as non-pollution and ease in production in comparison with inorganic photoconductive materials, have been developed.

In general, an organic photoreceptor is comprised of an electroconductive support and a photosensitive layer disposed thereon. Photoreceptors are classified into a so-called single-layer photoreceptor having a single photosensitive layer (single photosensitive layer) containing a binder resin dissolving or dispersing a photoconductive material therein; and a so-called multilayered photoreceptor comprising a plurality of laminated layers (laminated photosensitive layer) including a charge-generating layer containing a charge-generating material and a charge-transporting layer containing a charge-transporting material.

In the organic photoreceptor, changes in use environment of the photoreceptor or changes in electric characteristics during repeated use may cause various defects in an image formed by using the photoreceptor. In a method as one technique for solving them, a method in which an undercoat layer containing a binder resin and titanium oxide particles is provided between an electroconductive substrate and a photosensitive layer in order to stably form a good image (for example, refer to Patent Document 1), is known.

The layer, which the organic photoreceptor has, is generally formed by applying and drying a coating liquid prepared by dissolving or dispersing a material in a solvent, because of its high productivity. In such a case, since the titanium oxide particles and the binder resin are incompatible with each other in the undercoat layer containing titanium oxide particles and binder resins, the coating liquid for forming the undercoat layer is provided in the form of a dispersion of titanium oxide particles.

Such a coating liquid has generally been produced by wet-dispersing titanium oxide particles in an organic solvent using a known mechanical pulverizer, such as a ball mill, a sand grind mill, a planetary mill, or a roll mill, by spending a long period of time (for example, refer to Patent Document 1). Furthermore, it is disclosed that when titanium oxide particles are dispersed in a coating liquid for forming an undercoat layer using a dispersion medium, an electrophotographic photoreceptor that exhibits excellent characteristics in repeated charging-exposure cycles even under conditions of low temperature and low humidity can be provided by using titania or zirconia as a material of the dispersion medium (for example, refer to Patent Document 2).

In the organic photoreceptor, known hole-transporting materials, which are charge-transporting materials, are, for example, hydrazone compounds, triphenylamine compounds, benzidine compounds, stilbene compounds, and butadiene compounds, and known electron-transporting materials, which are charge-transporting materials, are, for example, diphenoquinone compounds.

The charge-transporting material is selected in consideration of characteristics demanded in the photoreceptor. Examples of the characteristics include: (1) characteristic of electrostatic charge generated by corona discharge is high in a dark place, (2) attenuation of the charge generated by the corona discharge is low in a dark place, (3) the charge is rapidly dissipated by irradiation with light, (4) the residual electric charge after the irradiation with light is low, (5) an increase in the residual potential and a decrease in the initial potential are small in repeated use, and (6) changes in the electrophotographic characteristics caused by environmental changes, such as temperature and humidity, are small.

Various charge-transporting materials, such as a hydrazone compound, have been hitherto proposed for improving these characteristics (for example, refer to Patent Documents 3 to 8).

[Patent Document 1] Japanese Unexamined Patent Application Publication No. HEI 11-202519

[Patent Document 2] Japanese Unexamined Patent Application Publication No. HEI 6-273962

[Patent Document 3] Japanese Patent Publication No. SHO 55-42380

[Patent Document 4] Japanese Patent Publication No. SHO 58-32372

[Patent Document 5] Japanese Unexamined Patent Application Publication No. SHO 61-295558

[Patent Document 6] Japanese Unexamined Patent Application Publication No. SHO 58-198043

[Patent Document 7] Japanese Patent Publication HEI No. 5-42661

[Patent Document 8] Japanese Patent Publication No. HEI 7-21646

### DISCLOSURE OF INVENTION

### Problems to be Solved by the Invention

The above-mentioned various charge-transporting materials are useful as hole-transporting agents for electrophotographic photoreceptors. In particular, an electrophotographic photoreceptor with a photosensitive layer containing a hole-transporting agent having an arylamine skeleton can have, for example, excellent responsibility.

In an image-forming apparatus not having means for initialization (charge elimination), such as preexposure, after a series of image-formation processes, i.e., charging, exposure, development, and transfer, using an electrophotographic photoreceptor and before charging for the succeeding image formation, an image formed in the preceding one turn of the photoreceptor appears in a half-tone image output, that is, so-called ghosting readily occurs.

On the other hand, image-forming apparatuses without an optical charge elimination process have come into wide use along with recent miniaturization and a reduction in cost of image-forming apparatuses. A requirement of such image-forming apparatuses, in particular, color-image-forming apparatuses is little ghosting.

Using a hole-transporting agent having an arylamine skeleton in the photosensitive layer of an electrophotographic photoreceptor can suppress the above-mentioned ghosting. However, even in the case using the hole-transporting agent having the arylamine skeleton, the requirement cannot be sufficiently satisfied in some image-forming apparatuses because of recent speeding up of image forming and an increasing requirement for higher quality of images.

The present invention has been made in consideration of the above-described problems, and it is an object to provide an electrophotographic photoreceptor that exhibits high sensitivity and low residual potential and can form a high-quality image, an image-forming apparatus and an electrophotographic cartridge that use it.

### Means for Solving the Problems

The present inventors have conducted intensive studies for solving the above-mentioned problems in view of a combination of an undercoat layer and a charge-transporting material and, as a result, have found the fact that a photoreceptor including a combination of a specific undercoat layer and a specific arylamine compound exhibits particularly high sensitivity, low residual potential, superior characteristics in repeated use, and reduced image defects. The present invention has been thus completed.

Accordingly, an aspect of the present invention lies in an electrophotographic photoreceptor including an undercoat layer containing metal oxide particles and a binder resin on an electroconductive support, and a photosensitive layer disposed on the undercoat layer, wherein the metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3; and the photosensitive layer contains a compound represented by the following Formula (I):

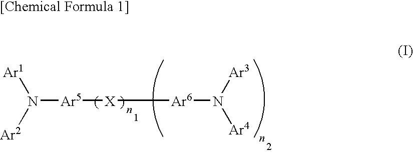

(in Formula (I), Ar¹ to Ar⁶ each independently represent an aromatic moiety that may have a substituent; X represents an organic moiety that may have a substituent; and n₁ and n₂ each independently represent an integer of 0 to 2) (claim 1).

In this aspect, in Formula (I), Ar¹ preferably has a fluorene structure (claim 2).

In addition, in Formula (I), X preferably represents a phenylene group (claim 3).

Furthermore, in Formula (I), preferably, n₂ is 1 and X represents an alkylidene group that may have a substituent (claim 4).

Another aspect of the present invention lies in an image-forming apparatus including the above-mentioned electrophotographic photoreceptor, charging means for charging the electrophotographic photoreceptor, image exposing means for forming an electrostatic latent image by conducting image exposure to the charged electrophotographic photoreceptor, development means for developing the electrostatic latent image with toner, and transfer means for transferring the toner to a transfer object (claim 5).

Another aspect of the present invention lies in an electrophotographic cartridge including the above-mentioned electrophotographic photoreceptor and at least one of charging means for charging the electrophotographic photoreceptor, image exposing means for forming an electrostatic latent image by conducting image exposure to the charged electrophotographic photoreceptor, development means for developing the electrostatic latent image with toner, and transfer means for transferring the toner to a transfer object (claim 6).

### ADVANTAGES

The present invention can provide an electrophotographic photoreceptor that exhibits high sensitivity and low residual potential, hardly has ghosting, and can form a high-quality image; and an image-forming apparatus and an electrophotographic cartridge that use it.

### BRIEF DESCRIPTION OF DRAWINGS

FIG. 1 is a longitudinal cross-sectional view schematically illustrating a structure of a wet agitating ball mill according to an embodiment of the present invention;

FIG. 2 is an enlarged longitudinal cross-sectional view schematically illustrating a mechanical seal used in a wet agitating ball mill according to an embodiment of the present invention;

FIG. 3 is a longitudinal cross-sectional view schematically illustrating another example of a wet agitating ball mill according to an embodiment of the present invention;

FIG. 4 is a horizontal cross-sectional view schematically illustrating a separator of the wet agitating ball mill shown in FIG. 3; and

FIG. 5 is a schematic view illustrating the main structure of an embodiment of an image-forming apparatus provided with an electrophotographic photoreceptor of the present invention.

### REFERENCE NUMERALS

1 photoreceptor
2 charging device (charging roller)
3 exposure device
4 development device
5 transfer device
6 cleaning device
7 fixing device
14 separator
15 shaft
16 jacket
17 stator
19 discharging path
21 rotor
24 pulley
25 rotary joint
26 raw slurry supplying port
27 screen support
28 screen
29 product slurry outlet
31 disk
32 blade
35 valve element
41 development bath
42 agitator
43 supply roller
44 development roller
45 regulation member
71 upper fixing member (fixing roller)
72 lower fixing member (fixing roller)
73 heating device
100 sealing
101 mating ring
102 spring
103 fitting groove
104 O-ring
105 shaft
106 separator
107 spacer
108 rotor
109 stopper
110 screw
111 discharging path
112 hole
113 spacer
114 blade fitting groove
115 disk
116 blade
T toner
P transfer material (paper, medium)

### BEST MODES FOR CARRYING OUT THE INVENTION

Embodiments of the present invention will now be described in detail, but the description of components below is merely exemplary embodiments of the present invention. Accordingly, various modifications can be made within the scope of the present invention.

An electrophotographic photoreceptor of the present invention includes an undercoat layer containing metal oxide particles and a binder resin on an electroconductive support, and a photosensitive layer disposed on the undercoat layer. Furthermore, in the electrophotographic photoreceptor of the present invention, a compound containing the metal oxide particles as the undercoat layer is used, which has a predetermined particle diameter distribution, and the photosensitive layer contains a specific arylamine compound.

### [I. Electroconductive Support]

Any electroconductive support can be used without particular limitation, and mainly formed of metal materials such as aluminum, aluminum alloys, stainless steel, copper, and nickel; resin materials provided with conductivity by being mixed with an electroconductive powder, such as a metal, carbon, or tin oxide powder; and resins, glass, and paper on which the surfaces are coated with an electroconductive material, such as aluminum, nickel, or ITO (indium oxide-tin oxide alloy), by vapor deposition or coating.

In addition, the shape of the electroconductive support may be, for example, a drum, a sheet, or a belt. Furthermore, an electroconductive material having an appropriate resistance value may be coated on an electroconductive support of a metal material for controlling conductivity or surface properties or for covering defects.

Furthermore, in the case of the electroconductive support comprising a metal material such as an aluminum alloy, a metal material may be used after anodization treatment. If the anodization treatment is performed, it is desirable to conduct pore sealing treatment by a known method.

For example, an anodic oxide coating is formed by anodization in an acidic bath of, for example, chromic acid, sulfuric acid, oxalic acid, boric acid, or sulfamic acid. Among these acidic baths, anodization in sulfuric acid gives a particularly effective result. In the case of the anodization in sulfuric acid, preferred conditions are a sulfuric acid concentration of 100 to 300 g/L, a dissolved aluminum concentration of 2 to 15 g/L, a liquid temperature of 15 to 30° C., a bath voltage of 10 to 20 V, and a current density of 0.5 to 2 A/dm², but the conditions are not limited thereto.

It is preferable to conduct pore sealing to the resulting anodic oxide coating. The pore sealing may be conducted by a known method and is preferably performed by, for example, low-temperature pore sealing treatment, dipping in an aqueous solution containing nickel fluoride as a main component, or high-temperature pore sealing treatment, dipping in an aqueous solution containing nickel acetate as a main component.

The concentration of the nickel fluoride aqueous solution used in the low-temperature pore sealing treatment may be appropriately determined, but the concentration in the range of 3 to 6 g/L can give a more better result. Furthermore, in order to smoothly carry out the pore sealing treatment, the treatment temperature range is usually 25° C. or higher and preferably 30° C. or higher and usually 40° C. or lower and preferably 35° C. or lower. In addition, from the same viewpoint, the pH range of the nickel fluoride aqueous solution is usually 4.5 or more and preferably 5.5 or more and usually 6.5 or less and preferably 6.0 or less. Examples of a pH regulator include oxalic acid, boric acid, formic acid, acetic acid, sodium hydroxide, sodium acetate, and aqueous ammonia. The treating time is preferably in the range of one to three minutes per micrometer of coating thickness. Furthermore, the nickel fluoride aqueous solution may contain, for example, cobalt fluoride, cobalt acetate, nickel sulfate, or a surfactant in order to further improve the coating physical properties. Then, washing with water and drying lead to complete the low-temperature pore sealing treatment.

On the other hand, examples of the pore sealing agent for the high-temperature pore sealing treatment can include metal salt aqueous solutions of nickel acetate, cobalt acetate, lead acetate, nickel-cobalt acetate, and barium nitrate, and a nickel acetate aqueous solution is particularly preferred. The nickel acetate aqueous solution is preferably used in the concentration range of 5 to 20 g/L. The treatment temperature range is usually 80° C. or higher and preferably 90° C. or higher and usually 100° C. or lower and preferably 98° C. or lower. In addition, the pH of the nickel acetate aqueous solution is preferably in the range of 5.0 to 6.0. Here, examples of the pH regulator can include aqueous ammonia and sodium acetate. The treating time is usually 10 minutes or more and preferably 20 minutes or more. Furthermore, the nickel acetate aqueous solution may also contain, for example, sodium acetate, organic carboxylic acid, or an anionic or nonionic surfactant in order to improve physical properties of the coating. In addition, high-temperature water or high-temperature water vapor substantially not containing salts may be used for the treatment. Then, washing with water and drying lead to complete the high-temperature pore sealing treatment.

When the anodic oxide coating has a long average thickness, severer pore sealing conditions may be required for treatment in a higher concentration of pore sealing solution, or higher temperature treatment for a longer period of time. In such a case, the productivity is decreased, and also surface defects, such as stains, blot, or blooming, may tend to occur on the coating surface. From these viewpoints, the anodic oxide coating is preferably formed so as to have an average thickness of usually 20 μm or less and particularly 7 μm or less.

The surface of the electroconductive support may be smooth or may be roughened by specific milling or by grinding treatment. In addition, the surface may be roughened by mixing particles having an appropriate particle diameter to the material constituting the support. Furthermore, a drawing tube can be directly used, without conducting milling treatment, for cost reduction. In particular, in the case of use of an aluminum support without milling treatment, such as drawing treatment, impacting treatment, or die processing treatment, blot, adherents such as foreign materials, and small scratches present on the surface are eliminated by the treatment to give a uniform and clean support, and it is therefore preferred.

### [II. Undercoat Layer]

The undercoat layer contains metal oxide particles and a binder resin. In addition, the undercoat layer may contain other components that do not significantly impair the effects of the present invention.

The undercoat layer according to the present invention is provided between the electroconductive support and the photosensitive layer and has at least one function selected from the group including an improvement in adhesion between the electroconductive support and the photosensitive layer, covering of blot and scratches of the electroconductive support, prevention of carrier injection due to impurities or nonuniformity in surface physical property, an improvement in uniformity of electric characteristics, prevention of a decrease in surface potential during repeated use, and prevention of a change in local surface potential, which causes image defects. The undercoat layer is not essential for achieving photoelectric characteristics.

### [II-1. Metal Oxide Particles]

### [II-1-1. Type of Metal Oxide Particles]

Any metal oxide particle that can be used in an electrophotographic photoreceptor can be used as the metal oxide particles according to the present invention.

Examples of metal oxides that form the metal oxide particles include metal oxides containing single metal elements, such as titanium oxide, aluminum oxide, silicon oxide, zirconium oxide, zinc oxide, and iron oxide; and metal oxides containing plural metal elements, such as calcium titanate, strontium titanate, and barium titanate. Among them, metal oxide particles comprising a metal oxide having a band gap of 2 to 4 eV are preferred. A significantly low band gap accelerates carrier injection from the electroconductive support, resulting in image defects such as black spots and color spots. A significantly high band gap precludes charge transfer due to electron trapping, resulting in poor electric characteristics.

Furthermore, the metal oxide particles may be composed of one kind of particles or any combination of different kinds of particles in any ratio. In addition, the metal oxide particles may be composed of one metal oxide or any combination of two or more metal oxides in any ratio.

The metal oxide forming the metal oxide particles is preferably titanium oxide, aluminum oxide, silicon oxide, or zinc oxide, more preferably titanium oxide or aluminum oxide, and particularly preferably titanium oxide.

Furthermore, the metal oxide particles may have any crystal form that does not significantly impair the effects of the present invention. For example, the crystal form of the metal oxide particles comprising titanium oxide (i.e., titanium oxide particles) is not limited and may be any of rutile, anatase, brookite, or amorphous. In addition, these crystal forms of the titanium oxide particles may be any combination of two or more from the above different crystal states.

Furthermore, the metal oxide particles may be subjected to various kinds of surface treatment, for example, treatment with a treating agent such as an inorganic material, for example, tin oxide, aluminum oxide, antimony oxide, zirconium oxide, or silicon oxide or an organic material, for example, stearic acid, a polyol, or an organic silicon compound.

In particular, when titanium oxide particles are used as the metal oxide particles, surface treatment is preferably conducted with an organic silicon compound. Examples of the organic silicon compound include silicone oils such as dimethylpolysiloxane and methylhydrogenpolysiloxane; organosilanes such as methyldimethoxysilane and diphenyldimethoxysilane; silazanes such as hexamethyldisilazane; and silane coupling agents such as vinyltrimethoxysilane, γ-mercaptopropyltrimethoxysilane, and γ-aminopropyltriethoxysilane.

Furthermore, the metal oxide particles are preferably treated with a silane treating agent represented by the following Formula (i). This silane treating agent has high reactivity with metal oxide particles and is a favorable treating agent.

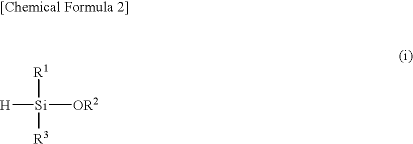

In Formula (i), R¹ and R² each independently represent an alkyl group. The carbon numbers of R¹ and R² are not limited, but are each usually 1 or more and usually 18 or less, preferably 10 or less, and more preferably 6 or less. Preferable examples of R¹ and R² include a methyl group and an ethyl group.

In addition, in Formula (i), R³ represents an alkyl group or an alkoxy group. The carbon number of R³ is not limited, but is usually 1 or more and usually 18 or less, preferably 10 or less, and more preferably 6 or less. Preferable examples of R³ include a methyl group, an ethyl group, a methoxy group, and an ethoxy group.

Larger carbon numbers of R¹ to R³ may cause less reactivity with metal oxide particles, or lower dispersion stability of the metal oxide particles after treatment in a coating liquid for forming an undercoat layer.

The outermost surfaces of these surface-treated metal oxide particles are usually treated with a treating agent described above. In such a case, the above-described surface treatment may be one kind of treatment or may be any combination of two or more kinds of treatment. For example, before the surface treatment with a silane treating agent represented by Formula (i), treatment with a treating agent, such as aluminum oxide, silicon oxide, or zirconium oxide, may be conducted. Furthermore, any combination of metal oxide particles subjected to different kinds of surface treatment in any ratio may be employed.

Examples of commercial products of the metal oxide particles according to the present invention are shown below, but the metal oxide particles according to the present invention are not limited to the products shown below.

Commercially available examples of the titanium oxide particles include ultrafine titanium oxide particles without surface treatment, “TTO-55 (N)”; ultrafine titanium oxide particles coated with Al₂O₃, “TTO-55 (A)” and “TTO-55 (B)”; ultrafine titanium oxide particles surface-treated with stearic acid, “TTO-55 (C)”; ultrafine titanium oxide particles surface-treated with Al₂O₃ and organosiloxane, “TTO-55 (S)”; high-purity titanium oxide “CR-EL”; sulfuric acid process titanium oxide, “R-550”, “R-580”, “R-630”, “R-670”, “R-680”, “R-780”, “A-100”, “A-220”, and “W-10”; chlorine process titanium oxide, “CR-50”, “CR-58”, “CR-60”, “CR-60-2”, and “CR-67”; and electroconductive titanium oxide, “SN-100P”, “SN-100D”, and “ET-300 W” (these are manufactured by Ishihara Industry Co., Ltd.). In addition, examples also include titanium oxide such as “R-60”, “A-110”, and “A-150”; titanium oxide coated with Al₂O₃, “SR-1”, “R-GL”, “R-5N”, “R-5N-2”, “R-52N”, “Rk-1”, and “A-SP”; titanium oxide coated with SiO₂ and Al₂O₃, “R-GX” and “R-7E”; titanium oxide coated with ZnO, SiO₂, and Al₂O₃, “R-650”; and titanium oxide coated with ZrO₂ and Al₂O₃, “R-61N” (these are manufactured by Sakai Chemical Industry Co., Ltd.); titanium oxide surface-treated with SiO₂ and Al₂O₃, “TR-700”. Moreover, examples also include titanium oxide surface-treated with ZnO, SiO₂, and Al₂O₃, “TR-840” and “TA-500”; titanium oxide without surface treatment, “TA-100”, “TA-200”, and “TA-300”; and titanium oxide surface-treated with Al₂O₃, “TA-400” (these are manufactured by Fuji Titanium Industry Co., Ltd.); and titanium oxide without surface treatment, “MT-150 W” and “MT-500B”; titanium oxide surface-treated with SiO₂ and Al₂O₃, “MT-100SA” and “MT-500SA”; and titanium oxide surface-treated with SiO₂, Al₂O₃ and organosiloxane, “MT-100SAS” and “MT-500SAS” (these are manufactured by Tayca Corp.).

Commercially available examples of the aluminum oxide particles include “Aluminium Oxide C” (manufactured by Nippon Aerosil Co., Ltd.).

Commercially available examples of the silicon oxide particles include “200CF” and “R972” (manufactured by Nippon Aerosil Co., Ltd.) and “KEP-30” (manufactured by Nippon Shokubai Co., Ltd.).

Commercially available examples of the tin oxide particles include “SN-100P” (manufactured by Ishihara Industry Co., Ltd.).

Commercially available examples of the zinc oxide particles include “MZ-305S” (manufactured by Tayca Corp.).

### [II-1-2. Physical Properties of Metal Oxide Particles]

The metal oxide particles according to the present invention satisfy the following requirements for the particle diameter distribution. That is, the metal oxide particles have a volume average particle diameter of 0.1 μm or less and a 90% cumulative particle diameter of 0.3 μm or less which are measured by a dynamic light-scattering method in a liquid containing the undercoat layer of the present invention dispersed in a solvent mixture of methanol and 1-propanol at a weight ratio of 7:3 (hereinafter, optionally, referred to as “dispersion for undercoat layer measurement”).

This point will be described in detail below.

### [Regarding Volume Average Particle Diameter of Metal Oxide Particles]

The metal oxide particles according to the present invention have a volume average particle diameter of 0.1 μm or less, preferably 95 nm or less, and more preferably 90 nm or less which is measured in a dispersion for undercoat layer measurement by the dynamic light-scattering method. The volume average particle diameter has no lower limit, but is generally 20 nm or more. The electrophotographic photoreceptor of the present invention, which satisfies the above-mentioned range, is stabilized in repeated exposure-charge characteristics under low temperature and low humidity, and the occurrence of image defects, such as black spots and color spots, in the resulting image can be suppressed.

### [Regarding 90% Cumulative Particle Diameter of Metal Oxide Particles]

The metal oxide particles according to the present invention have a 90% cumulative particle diameter of 0.3 μm or less, preferably 0.25 μm or less, and more preferably 0.2 μm or less which is measured in a dispersion for undercoat layer measurement by the dynamic light-scattering method. The 90% cumulative particle diameter has no lower limit, but is generally 10 nm or more, preferably 20 nm or more, and more preferably 50 nm or more. In conventional electrophotographic photoreceptors, the undercoat layer contains huge metal oxide particle agglomerates that are formed by agglomeration of the metal oxide particles and extend across the undercoat layer from one surface to the other. Such huge metal oxide particle agglomerates may cause a defect in an image formed. Furthermore, in the case using contact-type charging means, charge may migrate from the charged photosensitive layer to an electroconductive support through the metal oxide particles, and thereby the charging may not be properly achieved. However, in the electrophotographic photoreceptor of the present invention, since the 90% cumulative particle diameter is very small, the number of metal oxide particles having a large size such as to cause the above-described defect is significantly reduced. As a result, in the electrophotographic photoreceptor of the present invention, occurrence of the defect and improper charging can be suppressed, and thereby a high-quality image can be formed.

### [Methods for Measuring Volume Average Particle Diameter and 90% Cumulative Particle Diameter]

The volume average particle diameter and the 90% cumulative particle diameter of the metal oxide particles according to the present invention are determined by preparing a dispersion for undercoat layer measurement by dispersing the undercoat layer in a solvent mixture of methanol and 1-propanol at a weight ratio of 7:3 (this functions as a dispersion medium in the measurement of the particle size); and measuring particle size distribution of the metal oxide particles in the dispersion for undercoat layer measurement by a dynamic light-scattering method.

In the dynamic light-scattering method, the particle size distribution is determined by irradiating finely dispersed particles with laser light to detect the scattering (Doppler shift) of light beams having different phases depending on the velocity of the Brownian motion of these particles. Values of the volume average particle diameter and 90% cumulative particle diameter in the dispersion for undercoat layer measurement are those when the metal oxide particles are stably dispersed in the dispersion for undercoat layer measurement and do not mean particle diameters in the formed undercoat layer. Specifically, actual measurements of the volume average particle diameter and 90% cumulative particle diameter are conducted with a dynamic light-scattering particle size analyzer (MICROTRAC UPA, model: 9340-UPA, manufactured by Nikkiso Co., Ltd., hereinafter abbreviated to UPA) under the conditions shown below. The actual measurement is conducted according to the instruction manual of the particle size analyzer (Nikkiso Co., Ltd., Document No. T15-490A00, revision No. E).

### Setting of the Dynamic Light-Scattering Particle Size Analyzer

Upper measurement limit: 5.9978 μm

Lower measurement limit: 0.0035 μm

Number of channels: 44

Measurement time: 300 sec.

Particle transparency: absorptive

Particle refractive index: N/A (not applicable)

Particle shape: non-spherical

Density: 4.20 g/cm³ (*)

Dispersion medium: methanol/1-propanol=7/3

Refractive index of dispersion medium: 1.35

(*) This density value is applicable to titanium dioxide particles, and, for other particles, values described in the instruction manual are used.

The amount of the solvent mixture used, as a dispersion medium, of methanol and 1-propanol (weight ratio: methanol/1-propanol=7/3, refractive index=1.35) is adjusted such that the sample concentration index (SIGNAL LEVEL) of the dispersion for undercoat layer measurement ranges from 0.6 to 0.8.

The particle size by dynamic light-scattering is measured at 25° C.

The volume average particle diameter and the 90% cumulative particle diameter of the metal oxide particles according to the present invention are defined as follows: When the particle size distribution is measured by the dynamic light-scattering method describe above, and when the cumulative curve of the volume particle size distribution is plotted from the minimum particle size by the dynamic light-scattering method where the total volume of the metal oxide particles is 100%, the particle size at a point of 50% in the cumulative curve is defined as the volume average particle diameter Median diameter), and the particle size at a point of 90% in the cumulative curve is defined as the 90% cumulative particle diameter.

### [Other Physical Properties]

The metal oxide particles according to the present invention may have any average primary particle diameter that does not significantly impair the effects of the present invention. However, the average primary particle diameter of the metal oxide particles according to the present invention is usually 1 nm or more and preferably 5 nm or more and usually 100 nm or less, preferably 70 nm or less, and more preferably 50 nm or less.

Furthermore, this average primary particle diameter can be determined based on the arithmetic mean value of the diameters of particles that are directly observed with a transmission electron microscope (hereinafter, optionally, referred to as “TEM”).

Also, the refractive index of the metal oxide particles according to the present invention does not have any limitation, and those that can be used in electrophotographic photoreceptors can be used. The refractive index of the metal oxide particles according to the present invention is usually 1.3 or more and preferably 1.4 or more and usually 3.0 or less, preferably 2.9 or less, and more preferably 2.8 or less.

In addition, as the refractive index of metal oxide particles, reference values described in various publications can be used. For example, they are shown in the following Table 1 according to Filler Katsuyo Jiten (Filler Utilization Dictionary, edited by Filler Society of Japan, Taiseisha Ltd., 1994).

TABLE 1

| | Refractive index |
|---|---|
| Titanium oxide (rutile type) | 2.76 |
| Lead titanate | 2.70 |
| Potassium titanate | 2.68 |
| Titanium oxide (anatase type) | 2.52 |
| Zirconium oxide | 2.40 |
| Zinc sulfide | 2.37 to 2.43 |
| Zinc oxide | 2.01 to 2.03 |
| Magnesium oxide | 1.64 to 1.74 |
| Barium sulfate (sedimentation property) | 1.65 |
| Calcium sulfate | 1.57 to 1.61 |
| Aluminum oxide | 1.56 |
| Magnesium hydroxide | 1.54 |
| Calcium carbonate | 1.57 to 1.60 |
| Quartz glass | 1.46 |

The undercoat layer of the present invention can contain the metal oxide particles and the binder resin at any ratio that does not significantly impair the effects of the present invention. However, in the undercoat layer of the present invention, the amount of the metal oxide particles to one part by weight of the binder resin is usually 0.5 part by weight or more, preferably 0.7 part by weight or more, and more preferably 1.0 part by weight or more and usually 4 parts by weight or less, preferably 3.8 parts by weight or less, and more preferably 3.5 parts by weight or less. A smaller ratio of the metal oxide particles to the binder resin may deteriorate electric characteristics of the resulting electrophotographic photoreceptor, in particular, an increase in the residual potential. A larger ratio may increase image defects, such as black spots and color spots, in an image formed with the electrophotographic photoreceptor.

### [II-2. Binder Resin]

The undercoat layer of the present invention can contain any binder resin that does not significantly impair the effects of the present invention. In general, a binder resin that can be used is soluble in a solvent such as an organic solvent and is insoluble or has low solubility in and substantially immiscible with a solvent such as an organic solvent that is used in a coating liquid for forming a photosensitive layer.

Examples of such a binder resin include phenoxy, epoxy, polyvinylpyrrolidone, polyvinyl alcohol, casein, polyacrylic acid, celluloses, gelatin, starch, polyurethane, polyimide, and polyamide. These resins may be used alone or in the cured form with a curing agent. In particular, polyamide resins such as alcohol-soluble copolymerized polyamides and modified polyamides exhibit favorable dispersibility and coating characteristics, and are preferred.

Examples of the polyamide resin include so-called copolymerized nylons, such as copolymers of 6-nylon, 66-nylon, 610-nylon, 11-nylon, and 12-nylon; and alcohol-soluble nylon resins, such as chemically modified nylons, like N-alkoxymethyl-modified nylon and N-alkoxyethyl-modified nylon. Examples of commercially available products include “CM4000” and “CM8000” (these are manufactured by Toray Industries, Inc.), and “F-30K”, “MF-30”, and “EF-30T” (these are manufactured by Nagase Chemtex Corporation).

Among these polyamide resins, particularly preferred is a copolymerized polyamide resin containing a diamine component corresponding to a diamine represented by the following Formula (ii) (hereinafter, optionally, referred to as “diamine component corresponding to Formula (ii)”).

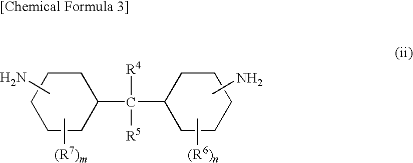

In Formula (ii), each of R⁴ to R⁷ represents a hydrogen atom or an organic substituent, and m and n each independently represent an integer of from 0 to 4. When a plurality of the substituents are present, these substituents may be the same or different from each other.

Preferable examples of the organic substituent represented by R⁴ to R⁷ include hydrocarbon groups that may contain hetero atoms. Among them, preferred examples are alkyl groups such as a methyl group, an ethyl group, an n-propyl group, and an isopropyl group; alkoxy groups such as a methoxy group, an ethoxy group, an n-propoxy group, and an isopropoxy group; and aryl groups such as a phenyl group, a naphthyl group, an anthryl group, and a pyrenyl group. More preferred are an alkyl group and an alkoxy group; and particularly preferred are a methyl group and an ethyl group.

The number of the carbon atoms in the organic substituent represented by R⁴ to R⁷ is not limited as long as the effects of the present invention are not significantly impaired, and is usually 20 or less, preferably 18 or less, and more preferably 12 or less and usually 1 or more. A significantly large number of carbon atoms leads to low solubility to a solvent for preparation of a coating liquid for forming an undercoat layer, and poor storage stability of the coating liquid for forming an undercoat layer even if the resin can be dissolved.

The copolymerized polyamide resin containing a diamine component corresponding to Formula (ii) may contain a constitutional unit other than the diamine component corresponding to Formula (ii) (hereinafter, optionally, referred to as “other polyamide constituent” simply). Examples of the other polyamide constituent include lactams such as γ-butyrolactam, ε-caprolactam, and lauryllactam; dicarboxylic acids such as 1,4-butanedicarboxylic acid, 1,12-dodecanedicarboxylic acid, and 1,20-eicosanedicarboxylic acid; diamines such as 1,4-butanediamine, 1,6-hexamethylenediamine, 1,8-octamethylenediamine, and 1,12-dodecanediamine; and piperazine. Furthermore, the copolymerized polyamide resin may be, for example, a binary, tertiary, or quaternary copolymer of the constituent.

When the copolymerized polyamide resin containing the diamine component corresponding to Formula (ii) contains another polyamide constitutional unit, the amount of the diamine component corresponding to Formula (ii) to the total constituents is not limited, but is usually 5 mol % or more, preferably 10 mol % or more, and more preferably 15 mol % or more and usually 40 mol % or less and preferably 30 mol % or less. A significantly large amount of the diamine component corresponding to Formula (ii) may lead to poor stability of the coating liquid for forming an undercoat layer. A significantly small amount may lead to low stability of the electric characteristics under conditions of high temperature and high humidity against environmental changes of the electric characteristics.

Examples of the copolymerized polyamide resin are shown below. In these examples, the copolymerization ratio represents the feed ratio (molar ratio) of monomers.

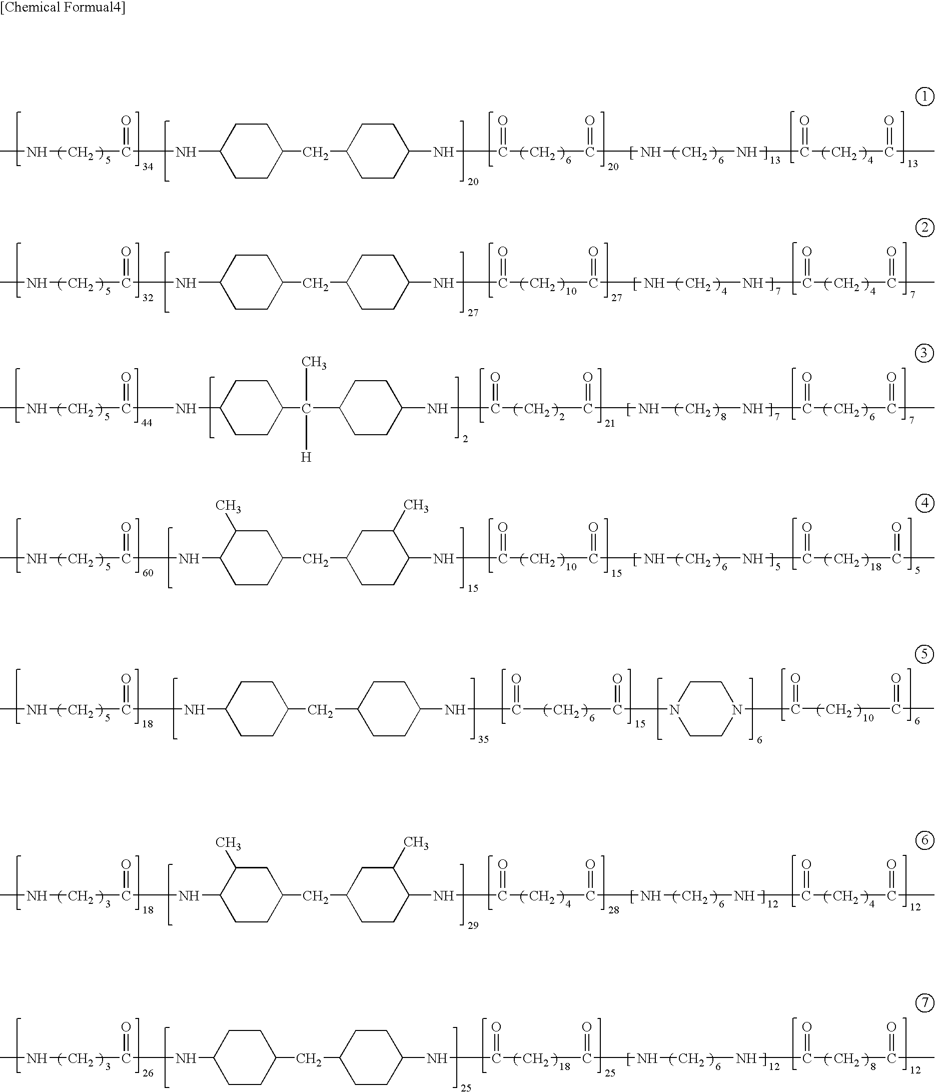

The copolymerized polyamide may be produced by any method without particular limitation and is properly produced by usual polycondensation of polyamide. For example, polycondensation such as melt polymerization, solution polymerization, or interfacial polymerization can be properly employed. Furthermore, in the polymerization, for example, a monobasic acid such as acetic acid or benzoic acid; or a monoacidic base such as hexylamine or aniline may be contained in a polymerization system as a molecular weight adjuster.

The binder resins may be used alone or in any combination of two or more kinds in any ratio.

Furthermore, the binder resin according to the present invention may have any number average molecular weight without limitation. For example, for a binder resin of copolymerized polyamide, the number average molecular weight of the copolymerized polyamide is usually 10000 or more and preferably 15000 or more and usually 50000 or less and preferably 35000 or less. If the number average molecular weight is too small or too large, the undercoat layer tends to be difficult to maintain the uniformity.

### [II-3. Other Component]

The undercoat layer of the present invention may contain other components in addition to the metal oxide particles and the binder resin, within a range that does not significantly impair the effects of the present invention. For example, the undercoat layer may contain any additive as the other component.

Examples of the additive include thermal stabilizers represented by sodium phosphite, sodium hypophosphite, phosphorous acid, hypophosphorous acid, and hindered phenol; other polymerization additives; and antioxidants. The additives may be used alone or in any combination of two or more kinds in any ratio.

### [II-4. Physical Properties of Undercoat Layer]

### [Film Thickness]

The undercoat layer may have any thickness. However, from the viewpoints of improvements in photoreceptive characteristics of the electrophotographic photoreceptor of the present invention and in coating characteristics, the thickness is usually 0.1 μm or more, preferably 0.3 μm or more, and more preferably 0.5 μm or more and usually 20 μm or less, preferably 15 μm or less, and more preferably 10 μm or less.

### [Surface Roughness]

The undercoat layer according to the present invention may have any surface profile, but usually has characteristic in-plane root mean square roughness (RMS), in-plane arithmetic mean roughness (Ra), and in-plane maximum roughness (P-V). These numerical values are obtained by applying the reference lengths of the root mean square height, arithmetic mean height, and maximum height in the specification of JIS B 0601:2001 to a reference plane. The in-plane root mean square roughness (RMS) represents the root mean square of Z(x), which are values in the height direction in the reference plane; the in-plane arithmetic mean roughness (Ra) represents the average of the absolute values of Z(x); and the in-plane maximum roughness (P-V) represents the sum of the maximum height and the maximum depth of Z(x).

The in-plane root mean square roughness (RMS) of the undercoat layer according to the present invention is usually 10 nm or more and preferably 20 nm or more and usually 100 nm or less and preferably 50 nm or less. A significantly smaller in-plane root mean square roughness (RMS) may impair the adhesion to an overlying layer. A significantly larger roughness may cause an uneven coating thickness of the overlying layer.

The in-plane arithmetic mean roughness (Ra) of the undercoat layer according to the present invention is usually 10 nm or more and usually 50 nm or less. A significantly smaller in-plane arithmetic mean roughness (Ra) may impair the adhesion to an overlying layer. A significantly larger roughness may cause an uneven coating thickness of the overlying layer.

The in-plane maximum roughness (P-V) of the undercoat layer according to the present invention is usually 100 nm or more and preferably 300 nm or more and usually 1000 nm or less and preferably 800 nm or less. A significantly smaller in-plane maximum roughness (P-V) may impair adhesion to an overlying layer. A significantly larger roughness may cause an uneven coating thickness of the overlying layer.

The values of indexes (RMS, Ra, P-V) representing the surface profile may be determined with any surface analyzer that can precisely measure irregularities in the reference plane. Particularly, it is preferred to determine these values by a method of detecting irregularities on the surface of the sample by combining high-precision phase shift detection with counting of the order of interference fringes using an optical interferometer. More specifically, they are preferably measured by an interference fringe addressing method at a Wave mode using Micromap manufactured by Ryoka Systems Inc.

### [Absorbance in Dispersion]

When the undercoat layer according to the present invention is dispersed in a solvent that can dissolve the binder resin binding the undercoat layer to prepare a dispersion (hereinafter, optionally, referred to as “dispersion for absorbance measurement”), the absorbance of the dispersion generally has specific physical properties.

The absorbance of the dispersion for absorbance measurement can be measured with a generally known absorption spectrophotometer. Since the conditions for measuring absorbance, such as a cell size and sample concentration, vary depending on physical properties of the metal oxide particles used, such as particle diameter and refractive index, in general, the sample concentration is properly adjusted so as not to exceed the detection limit of the detector within the wavelength region (400 nm to 1000 nm in the present invention) to be measured.

The cell size (light path length) used for the measurement is 10 mm. Any cell can be used as long as the cell is substantially transparent in the range of 400 nm to 1000 nm. Quartz cells are preferably used, and matched cells having the difference in transmittance characteristics between a sample cell and a standard cell within a predetermined range are particularly preferred.

In order to prepare a dispersion for absorbance measurement by dispersing the undercoat layer according to the present invention, overlying layers, such as photosensitive layer, disposed on the undercoat layer are removed by dissolving the layers in a solvent that can dissolve these layers on the undercoat layer, but not substantially dissolve the binder resin binding the undercoat layer, and then the binder resin in the undercoat layer is dissolved in a solvent to give the dispersion for absorbance measurement. The solvent that can dissolve the undercoat layer preferably does not have high light absorption in the wavelength region of 400 nm to 1000 nm.

Examples of the solvent that can dissolve the undercoat layer include alcohols such as methanol, ethanol, 1-propanol, and 2-propanol. In particular, methanol, ethanol, and 1-propanol are preferred. These solvents may be used alone or in any combination of two or more kinds in any ratio.

In particular, in a dispersion for absorbance measurement dispersing the undercoat layer according to the present invention in a solvent mixture of methanol and 1-propanol at a weight ratio of 7:3, the difference between the absorbance to light with 400 nm wavelength and the absorbance to light with 1000 nm wavelength (absorbance difference) is as follows: In case of a refractive index of metal oxide particles of 2.0 or more, the absorbance difference is usually 0.3 (Abs) or less and preferably 0.2 (Abs) or less. In case of a refractive index of metal oxide particles of less than 2.0, the absorbance difference is usually 0.02 (Abs) or less and preferably 0.01 (Abs) or less.

The absorbance depends on the solid content of a liquid to be measured. Therefore, in the absorbance and [SIC] the measurement of the absorbance, the concentration of the metal oxide particles dispersed in the dispersion is preferably adjusted to the range of 0.003 weight % to 0.0075 weight %.

### [Regular Reflection Rate of Undercoat Layer]

The regular reflection rate of the undercoat layer according to the present invention usually shows a value specific to the present invention. The regular reflection rate of the undercoat layer according to the present invention means the rate of the regular reflection of an undercoat layer on an electroconductive support to that of the electroconductive support. Since the regular reflection rate of the undercoat layer varies depending on the thickness of the undercoat layer, the reflectance here is defined as that when the thickness of the undercoat layer is 2 μm.

In the undercoat layer according to the present invention, in case of a refractive index of the metal oxide particles contained in the undercoat layer of 2.0 or more, the ratio of the regular reflectance of 480 nm light on the undercoat layer to the regular reflectance of 480 nm light on the electroconductive support is usually 50% or more, where the ratio is converted into that of the undercoat layer with a thickness of 2 μm.

On the other hand, in case of a refractive index of the metal oxide particles contained in the undercoat layer of less than 2.0, the ratio of the regular reflectance of 400 nm light on the undercoat layer to the regular reflectance of 400 nm light on the electroconductive support is usually 50% or more, where the ratio is converted into that of the undercoat layer with a thickness of 2 μm.

Here, even if the undercoat layer contains different types of metal oxide particles with refractive indices of 2.0 or more or different types of metal oxide particles with refractive indices less than 2.0, the regular reflection rate is preferably in the above-mentioned range. Furthermore, even if the undercoat layer contains both metal oxide particles with a refractive index of 2.0 or more and metal oxide particles with a refractive index less than 2.0, as in the case of the undercoat layer containing metal oxide particles with a refractive index of 2.0 or more, the ratio of the regular reflection of 480 nm light on the undercoat layer to the regular reflection of 480 nm light on the electroconductive support is preferably in the above-mentioned range (50% or more), where the regular reflection rate is converted into that of the undercoat layer with a thickness of 2 μm.

Hitherto, cases of the undercoat layer having a thickness of 2 μm are described in detail. In the electrophotographic photoreceptor according to the present invention, however, the thickness of the undercoat layer is not limited to 2 μm and may have any thickness. In the case of the undercoat layer having a thickness other than 2 μm, the regular reflection rate can be measured using a coating liquid for forming an undercoat layer (described below) that is used for forming the undercoat layer having a thickness other than 2 μm and forming an undercoat layer having a thickness of 2 μm on an electroconductive support equivalent to the electrophotographic photoreceptor and measuring the regular reflection rate of the undercoat layer. Alternatively, the regular reflection rate of the undercoat layer of the electrophotographic photoreceptor is measured, and then the regular reflection rate may be converted into that of an undercoat layer with a thickness of 2 μm.

A conversion process will be described below.

A layer having a small thickness dL and being perpendicular to the light is supposed for the detection of specific monochromatic light that passes through the undercoat layer, is regularly reflected on the electroconductive support, and then passes again through the undercoat.

A decrease in intensity −dI of the light that passed through the layer with a small thickness dL is supposed to be proportional to the intensity I before the light passes through the layer and the layer thickness dL, as is expressed by the equation (k is a constant) below.

−dI=kIdL (A).

Equation (A) can be modified as follows:

−dI/I=kdL (B).

By integrating both sides of Equation (B) over the intervals from I₀ to I and from 0 to L, respectively, the following equation is obtained. Here, I₀ represents the intensity of the incident light.

log(I₀/I)=kL (C).

Equation (C) is identical to one called Lambert's law in a solution system and can be applied to measurement of the reflectance in the present invention.

Equation (C) can be modified as follows:

I=I₀exp(−kL) (D).

The behavior of the incident light before it reaches the surface of an electroconductive support is represented by Equation (D).

The reflectance on the surface of a cylinder is represented by R═I₁/I₀ where I₁ represents the intensity of the reflected light, since the denominator of the regular reflection rate is reflected light of the incident light on the conductive support.

The light that reaches the surface of the electroconductive support in accordance with Equation (D) is regularly reflected after being multiplied by the reflectance R and then passes through the optical path L again toward the surface of the undercoat layer. That is, the following expression is obtained:

I=I₀exp(−kL)·R·exp(−kL) (E).

R═I₁/I₀ is assigned and the equation is further modified to obtain a relationship:

I/I₁=exp(−2kL) (F).

This is the reflectance of the undercoat layer relative to the reflectance of the electroconductive support and is defined as the regular reflection rate.

As described above, in the case of a 2 μm undercoat layer, the to-and-fro optical path length is 4 μm, and the reflectance T of the undercoat layer on an optional electroconductive support is a function of the thickness L of the undercoat layer (in this case, the optical path length is 2 L) and is represented by T(L). From Equation (F), the following equation is obtained:

T(L)=I/I₁=exp(−2kL) (G).

Furthermore, since the value that should be determined is T(2), L=2 is assigned to Equation (G) to obtain:

T(2)=I/I₁=exp(−4k) (H),

and k is deleted by Equations (G) and (H) to obtain:

T(2)=T(L)^{2/L} (I)

That is, at a thickness L (μm) of the undercoat layer, the reflectance T(2) for an undercoat layer of 2 μm thickness can be estimated with considerable accuracy by measuring the reflectance T(L) of the undercoat layer. The thickness L of the undercoat layer can be measured by any film thickness measuring apparatus such as a roughness meter.

### [III. Method for Forming Undercoat Layer]

The undercoat layer according to the present invention can be formed by any method without limitation. However, in general, the undercoat layer can be obtained by applying a coating liquid for forming an undercoat layer containing metal oxide particles and a binder resin onto the surface of an electroconductive support and drying the liquid.

### [III-1. Coating Liquid for Forming Undercoat Layer]

The coating liquid for forming an undercoat layer according to the present invention contains metal oxide particles and a binder resin. In addition, the coating liquid for forming an undercoat layer according to the present invention generally contains a solvent. Furthermore, the coating liquid for forming an undercoat layer according to the present invention may contain other components in a range that does not significantly impair the effects of the present invention.

### [III-1-1. Metal Oxide Particle]

The metal oxide particles are the same as those described as the metal oxide particles contained in the undercoat layer.

However, the particle diameter distribution of the metal oxide particles in the coating liquid for forming an undercoat layer according to the present invention, in general, should meet the following requirements: the volume average particle diameter and 90% cumulative particle diameter, measured by a dynamic light-scattering method, of the metal oxide particles in the coating liquid for forming an undercoat layer according to the present invention are the same as the volume average particle diameter and 90% cumulative particle diameter, measured by a dynamic light-scattering method, of the metal oxide particles in the dispersion for undercoat layer measurement described above, respectively.

Accordingly, in the coating liquid for forming an undercoat layer according to the present invention, the volume average particle diameter of the metal oxide particles is usually 0.1 μm or less (refer to [Regarding volume average particle diameter of metal oxide particles]).

The metal oxide particles in the coating liquid for forming an undercoat layer according to the present invention are desirably present in the form of primary particles. However, in general, it is rare, and, in most cases, the metal oxide particles are aggregated into secondary particles or are present as a mixture of the both. Therefore, the profile of the particle size distribution is significantly important in such a state.

Therefore, in the coating liquid for forming an undercoat layer according to the present invention, precipitation and a change in viscosity in the coating liquid for forming an undercoat layer are suppressed by controlling the volume average particle diameter of the metal oxide particles in the coating liquid for forming an undercoat layer to the aforementioned range (0.1 μm or less), resulting in uniformity of the thickness and the surface characteristics of the formed undercoat layer. On the other hand, a larger volume average particle diameter (larger than 0.1 μm) of the metal oxide particles leads to accelerated precipitation and a large change in viscosity in the coating liquid for forming an undercoat layer, resulting in irregularity of the thickness and the surface characteristics of the formed undercoat layer. This may adversely affect the quality of overlying layers (such as a charge-generating layer).

Furthermore, in the coating liquid for forming an undercoat layer according to the present invention, the metal oxide particles usually have a 90% cumulative particle diameter of 0.3 μm or less (refer to [Regarding 90% cumulative particle diameter of metal oxide particles]).

The metal oxide particles in the coating liquid for forming an undercoat layer according to the present invention are desirably present in the form of primary particles. However, actually, such metal oxide particles cannot be practically obtained. The present inventors have found the fact that when the 90% cumulative particle diameter is sufficiently small, concretely, when the 90% cumulative particle diameter is 0.3 μm or less, the coating liquid for forming an undercoat layer exhibits less gelation and a small change in viscosity and therefore can be stored for a long period of time, even if the metal oxide particles aggregate and that, as a result, the thickness and surface characteristics of the formed undercoat layer can be uniform. On the other hand, when the diameter of the metal oxide particles in the coating liquid for forming an undercoat layer is too large, the gelation and the change in viscosity of the liquid are large, resulting in the thickness and surface characteristics of the formed undercoat layer being not uniform. This may also adversely affect the quality of overlying layers (such as a charge-generating layer).

The volume average particle diameter and the 90% cumulative particle diameter of the metal oxide particles in the coating liquid for forming an undercoat layer are directly measured with the coating liquid for forming an undercoat layer, not the metal oxide particles in the dispersion for undercoat layer measurement. This method for measurement is different from that for measuring the volume average particle diameter and the 90% cumulative particle diameter of the metal oxide particles in the dispersion for undercoat layer measurement in the following points. In other points, this method for measuring the volume average particle diameter and the 90% cumulative particle diameter of the metal oxide particles in the coating liquid for forming an undercoat layer is the same as that of the volume average particle diameter and the 90% cumulative particle diameter of the metal oxide particles in the dispersion for undercoat layer measurement.

That is, in the measurement of the volume average particle diameter and the 90% cumulative particle diameter of the metal oxide particles in the coating liquid for forming an undercoat layer, the dispersion medium is the solvent used in the coating liquid for forming an undercoat layer, and the dispersion refractive index is that of the solvent used in the coating liquid for forming an undercoat layer. In addition, if the concentration of the coating liquid for forming an undercoat layer is too high and is outside of the range that a measurement apparatus can measure, the coating liquid for forming an undercoat layer is diluted with a solvent mixture of methanol and 1-propanol (weight ratio: methanol/1-propanol=7/3, refractive index=1.35) such that the resulting concentration of the coating liquid for forming an undercoat layer is within the measurable range of the measurement apparatus. For example, in the case of the aforementioned UPA, the coating liquid for forming an undercoat layer is diluted with a solvent mixture of methanol and 1-propanol into a sample concentration index (SIGNAL LEVEL) within the range from 0.6 to 0.8, which is suitable for measurement. Since, even if such dilution is conducted, it is believed that the volume particle diameter of the metal oxide particles in the coating liquid for forming an undercoat layer does not vary, the volume average particle diameter and the 90% cumulative particle diameter after the dilution are regarded as the volume average particle diameter and the 90% cumulative particle diameter of metal oxide microparticles in the coating liquid for forming the undercoat layer.

The absorbance of the coating liquid for forming an undercoat layer according to the present invention can be measured by a generally known absorption spectrophotometer. Since the conditions for measuring absorbance, such as a cell size and sample concentration, vary depending on physical properties, such as particle diameter and refractive index, of metal oxide particles used, the sample concentration is properly adjusted so as not to exceed the detection limit of a detector in a wavelength region (400 nm to 1000 nm in the present invention) to be measured. In the present invention, the concentration of the metal oxide particles in a sample of the coating liquid for forming an undercoat layer is controlled to 0.0075 weight % to 0.012 weight %. In general, the solvent for adjusting the sample concentration is the solvent used for the coating liquid for forming an undercoat layer. However, any solvent that has compatibility to the solvent of the coating liquid for forming an undercoat layer and the binder resin and does not cause turbid or the like and does not have high light absorption in a wavelength region of 400 nm to 1000 nm can be used. Examples of such solvents include alcohols such as methanol, ethanol, 1-propanol, and 2-propanol; hydrocarbons such as toluene and xylene; ethers such as tetrahydrofuran; and ketones such as methyl ethyl ketone and methyl isobutyl ketone.

The cell size (light path length) used for the measurement is 10 mm. Any cell substantially transparent in the range of 400 nm to 1000 nm can be used. Quartz cells are preferably used, and matched cells having different transmittance characteristics within a predetermined range between a sample cell and a standard cell are particularly preferred.

In a dispersion prepared by dispersing the coating liquid for forming an undercoat layer of the present invention in a solvent mixture of methanol and 1-propanol at a weight ratio of 7:3, the difference between the absorbance to light with 400 nm wavelength and the absorbance to light with 1000 nm wavelength is preferably 1.0 (Abs) or less for a refractive index of metal oxide particles of 2.0 or more, or is preferably 0.02 (Abs) or less for a refractive index of metal oxide particles of less than 2.0.

### [III-1-2. Binder Resin]

The binder resin contained in the coating liquid for forming an undercoat layer is the same as that contained in the undercoat layer, which has been described.

However, the binder resin may be contained in the coating liquid for forming an undercoat layer at any content that does not significantly impair the effects of the present invention, and is usually 0.5 weight % or more and preferably 1 weight % or more and usually 20 weight % or less and preferably 10 weight % or less.

### [III-1-3. Solvent]

Any solvent can be used as a solvent for the coating liquid for forming an undercoat layer (solvent for the undercoat layer) according to the present invention as long as it can dissolve the binder resin according to the present invention. The solvent is usually an organic solvent, and examples thereof include alcohols having five or less carbon atoms, such as methanol, ethanol, isopropyl alcohol, and normal propyl alcohol; halogenated hydrocarbons such as chloroform, 1,2-dichloroethane, dichloromethane, trichlene, carbon tetrachloride, and 1,2-dichloropropane; nitrogen-containing organic solvents such as dimethylformamide; and aromatic hydrocarbons such as toluene and xylene.

Furthermore, these solvents may be used alone or in any combination of two or more kinds in any ratio. Furthermore, even if a solvent alone cannot dissolve the binder resin according to the present invention, the solvent can be used in the form of a mixture with another solvent (for example, the organic solvents described above) that can dissolve the binder resin as the mixture. In general, a solvent mixture can advantageously reduce unevenness in coating.

In the coating liquid for forming an undercoat layer according to the present invention, the ratio of solid components, such as the metal oxide particles and the binder resin, to the solvent varies depending on the method for coating the coating liquid for forming an undercoat layer and may be determined such that uniform coating can be formed in the coating method that is applied. Specifically, the solid content in the coating liquid for forming an undercoat layer is usually 1 weight % or more and preferably 2 weight % or more and usually 30 weight % or less and preferably 25 weight % or less, from the viewpoints of stability and coating characteristics of the coating liquid for forming an undercoat layer.

### [III-1-4. Other Components]

Other components contained in the coating liquid for forming an undercoat layer are the same as those contained in the undercoat layer, which has been described above.

### [III-1-5. Advantage of Coating Liquid for Forming an Undercoat Layer]

The coating liquid for forming an undercoat layer according to the present invention has high storage stability. There are many measures of storage stability, for example, in the coating liquid for forming an undercoat layer according to the present invention, the rate of change in viscosity after storage for 120 days at room temperature compared to that immediately after the production (i.e., the value obtained by dividing a difference between the viscosity after storage for 120 days and the viscosity immediately after the production by the viscosity immediately after the production) is usually 20% or less, preferably 15% or less, and more preferably 10% or less. The viscosity can be measured by a method in accordance with JIS Z 8803 using an E-type viscometer (product name: ED, manufactured by Tokimec Inc.).

Furthermore, the use of the coating liquid for forming an undercoat layer according to the present invention enables highly efficient production of electrophotographic photoreceptors with high quality.

### [III-2. Method of Producing Coating Liquid for Forming an Undercoat Layer]

The coating liquid for forming an undercoat layer according to the present invention may be produced by any method without limitation. However, the coating liquid for forming an undercoat layer according to the present invention contains metal oxide particles as described above, and the metal oxide particles are present in the form of dispersion in the coating liquid for forming an undercoat layer. Therefore, the method of producing the coating liquid for forming an undercoat layer according to the present invention usually includes a step of dispersing the metal oxide particles.

The metal oxide particles may be dispersed in a solvent (hereinafter, optionally, the solvent used for dispersion is referred to as “dispersion solvent”) by wet dispersion using a known mechanical pulverizer (dispersing apparatus), such as a ball mill, a sand grind mill, a planetary mill, or a roll mill. It is believed that the metal oxide particles according to the present invention are dispersed so as to have the above-described predetermined particle diameter distribution through this dispersion step. The dispersion solvent may be that used in the coating liquid for forming an undercoat layer or may be another solvent. However, when a solvent other than the solvent used in the coating liquid for forming an undercoat layer is used as the dispersion solvent, the metal oxide particles and the solvent to be used in the coating liquid for forming an undercoat layer are necessarily mixed or subjected to solvent exchange after the dispersion. In such an occasion, it is preferable that the mixing or the solvent exchange be carried out so as to avoid aggregation of the metal oxide particles in order to maintain the predetermined particle diameter distribution.

Among wet dispersion methods, a dispersion using a dispersion medium is particularly preferred.

Any known dispersing apparatus can be used for dispersing using a dispersion medium, and examples thereof include a pebble mill, a ball mill, a sand mill, a screen mill, a gap mill, a vibration mill, a paint shaker, and an attritor. Among them, the dispersion apparatus that can disperse metal oxide particles by circulation is preferred. Furthermore, from the viewpoints of, for example, dispersion efficiency, fineness of final particle size, and easiness of continuous operation, wet agitating ball mills such as a sand mill, a screen mill, and a gap mill are particularly preferred. These mills may be either a vertical type or a horizontal type. In addition, the disk of the mill may have any shape, and, for example, a flat plate type, a vertical pin type, or a horizontal pin type can be used. A liquid circulating type sand mill is preferred.

The dispersion may be conducted with one type of dispersion apparatus or with any combination of two or more types.

In the dispersion using a dispersion medium, the volume average particle diameter and the 90% cumulative particle diameter of the metal oxide particles in the coating liquid for forming an undercoat layer can be adjusted in the above-mentioned ranges by using a dispersion medium having a predetermined average particle diameter.

That is, in the method of producing a coating liquid for forming an undercoat layer according to the present invention, the metal oxide particles are dispersed in a wet agitating ball mill such that the dispersion medium of the wet agitating ball mill has an average particle diameter of usually 5 μm or more and preferably 10 μm or more and usually 200 μm or less and preferably 100 μm or less. A dispersion medium having a smaller particle diameter tends to give a homogeneous dispersion within a shorter period of time. However, a dispersion medium having an excessively small particle diameter has significantly small mass, which may preclude efficient dispersion.

It is believed that the use of a dispersion medium having the above-described average particle diameter is a factor for adjusting the volume average particle diameter and the 90% cumulative particle diameter of metal oxide particles in a coating liquid for forming an undercoat layer within the desired ranges by the above-mentioned production method. Therefore, the coating liquid for forming an undercoat layer produced in a wet agitating ball mill with metal oxide particles that are dispersed using a dispersion medium having the above-mentioned average particle diameter favorably satisfies the requirements of the coating liquid for forming an undercoat layer according to the present invention.

Since the dispersion medium is usually spherical-shape, the average particle diameter can be determined by a sieving method using sieves described in, for example, JIS Z 8801:2000 or image analysis, and the density can be measured by Archimedes's method. Concretely, for example, the average particle diameter and the sphericity of the dispersion medium can be measured with an image analyzer represented by LUZEX50 manufactured by Nireco Corp.

The density of the dispersion medium is not limited, but is usually 5.5 g/cm³ or more, preferably 5.9 g/cm³ or more, and more preferably 6.0 g/cm³ or more. In general, a dispersion medium having a higher density tends to give homogeneous dispersion within a shorter time. The sphericity of the dispersion medium, which is used, is preferably 1.08 or less and more preferably 1.07 or less.

As the material of the dispersion medium, any known dispersion medium can be used, as long as it is insoluble in a dispersion solvent contained in the aforementioned slurry, has a specific gravity higher than that of the slurry, and does not react with the slurry nor decompose the slurry. Examples of the dispersion medium include steel balls such as chrome balls (bearing steel balls) and carbon balls (carbon steel balls); stainless steel balls; ceramic balls such as silicon nitride, silicon carbide, zirconium, and alumina balls; and balls coated with films of, for example, titanium nitride or titanium carbonitride. Among them, preferred are ceramic balls, and particularly preferred are fired zirconium balls are more preferred. More specifically, fired zirconium beads described in Japanese Patent No. 3400836 are particularly preferred.

The dispersion media may be used alone or in any combination of two or more kinds in any ratio.

Among the above-mentioned wet agitating ball mills, particularly preferably used is one including a cylindrical stator, a slurry supplying port disposed at one end of the stator, a slurry discharging port disposed at the other end of the stator, a rotor for agitating and mixing a dispersion medium packed in the stator and slurry supplied from the supplying port, and a separator that is rotatably connected to the discharging port and separates the dispersion medium and the slurry by the centrifugal force to discharge the slurry from the discharging port.

Here, the slurry contains at least metal oxide particles and a dispersion solvent.

Now, the structure of this wet agitating ball mill will be described in detail.

The stator is a tubular (usually, cylindrical) container having a hollow portion therein and is provided with a slurry supplying port at one end thereof and a slurry discharging port at the other end. In addition, the hollow portion of the inside is filled with a dispersion medium so that metal oxide particles in slurry are dispersed by the dispersion medium. Furthermore, the slurry is supplied to the inside of the stator from the supplying port, and the slurry in the stator is discharged from the discharging port to the exterior of the stator.

The rotor is disposed in the interior of the stator and agitates and mixes the dispersion medium and the slurry. The rotor may be of any type such as a pin, disk, or annular type.

Furthermore, the separator separates the dispersion medium and the slurry. This separator is connected to the discharging port of the stator, separates the slurry and the dispersion medium in the stator, and discharge the slurry from the discharging port of the stator to the exterior of the stator.

The separator used is rotatable and is desirably of an impeller-type. The separator is configured such that the dispersion medium and the slurry are separated from each other by centrifugal force that is generated by the rotation of the separator.

The separator may be rotated in synchronization with the rotor or independently of the rotor.

Furthermore, the wet agitating ball mill preferably includes a shaft serving as a rotary shaft of the separator. In addition, this shaft is preferably provided with a hollow discharging path communicating with the discharging port, at the center of the shaft. That is, it is preferable that the wet agitating ball mill includes at least a cylindrical stator, a slurry supplying port disposed at one end of the stator, a slurry discharging port disposed at the other end of the stator, a rotor agitating and mixing a dispersion medium packed in the stator and slurry supplied from the supplying port, an impeller separator that is connected to the discharging port and is rotatable to separate the dispersion medium and the slurry from each other by centrifugal force and discharge the slurry from the discharging port, and a shaft serving as the rotary shaft of the separator where a hollow discharging path connected to the discharging port is disposed in the center of the shaft.

The discharging path provided to the shaft connects the rotary center of the separator and the discharging port of the stator. Therefore, the slurry separated from the dispersion medium by the separator is transported to the discharging port through the discharging path and is then discharged from the discharging port to the exterior of the stator. The discharging path extends through the center of the shaft. Since the centrifugal force does not work at the center of the shaft, the slurry discharged has no kinetic energy. Consequently, wasteful kinetic energy is not generated and so excess energy is not consumed.

Such a wet agitating ball mill may be horizontally disposed, but is preferably vertically disposed in order to increase the filling ratio of the dispersion medium. In the vertical installation, the discharging port is preferably disposed at the upper end of the mill. Furthermore, the separator is desirably disposed at a position above the level of the packed dispersion medium.

When the discharging port is disposed at the upper end of the mill, the supplying port is disposed at the bottom of the mill. In this case, more preferably, the supplying port comprises a valve seat and a vertically movable valve element that is fitted to the valve seat and has a V-shape, a trapezoidal shape, or a cone shape so as to be in line contact with the edge of the valve seat. With this, an annular slit can be formed between the edge of the valve seat and the valve element to prevent a dispersion medium from passing through. Therefore, at the supplying port, slurry is supplied without deposition of the dispersion medium. In addition, it is possible to discharge the dispersion medium by spreading the slit by lifting the valve element or to seal the mill by closing the slit by lowering the valve element. Furthermore, since the slit is defined by the valve element and the edge of the valve seat, coarse particles (metal oxide particles) in the slurry are barely caught in and, even if caught, the particles can be readily removed upward or downward. Thus, occlusion hardly occurs.

In addition, coarse particles trapped in the slit can be removed from the slit by vertical vibration of the valve element with vibration means, and occlusion itself of the particles can also be prevented by the vibration. Furthermore, the vibration of the valve element applies shearing force to the slurry to decrease the viscosity thereof, resulting in an increased amount of slurry passing through the slit (i.e., the amount of supply). Any means can be used for vibrating the valve element without limitation. For example, mechanical means such as a vibrator, means of changing the pressure of compressed air that acts on a piston combined with the valve element, such as a reciprocating compressor or an electromagnetic switching valve of switching supply and discharge of compressed air, can be used.

Such a wet agitating ball mill is desirably provided with a screen for separating the dispersion medium and a slurry outlet at the bottom so that the slurry remaining in the wet agitating ball mill can be discharged after the completion of dispersion.

Furthermore, in the case that the wet agitating ball mill is vertically disposed, the shaft is pivoted at the upper end of the stator, an O-ring and a mechanical seal having a mating ring are disposed at a bearing portion bearing the shaft disposed at the upper end of the stator, the bearing portion is provided with an annular groove for fitting the O-ring, and the O-ring is fitted to the annular groove, it is preferable that a tapered cut broadening downward be provided at the lower side of the annular groove. That is, it is preferable that the wet agitating ball mill include a cylindrical vertical stator, a slurry supplying port disposed at the bottom of the stator, a slurry discharging port disposed at the upper end of the stator, a shaft pivoted at the upper end of the stator and rotated by driving means such as a motor, a pin-, disk-, or annular rotor fixed to the shaft and agitating/mixing the dispersion medium packed in the stator and the slurry supplied from the supplying port, a separator disposed near the discharging port and separating the dispersion medium from the slurry, and a mechanical seal disposed at the bearing portion bearing the shaft at the upper end of the stator, and that a tapered cut broadening downward be provided at the lower side of an annular groove for fitting an O-ring being in contact with a mating ring of the mechanical seal is fitted.

In this wet agitating ball mill, the mechanical seal is provided at the upper end of the stator above the level of the liquid in the center of the shaft at which the dispersion medium and the slurry substantially do not have kinetic energy. This can significantly reduce intrusion of the dispersion medium and the slurry into a gap between the mating ring of the mechanical seal and the lower side portion of the O-ring fitting groove.

Furthermore, the lower side of the annular groove for fitting the O-ring broadens downward by a cut so that the clearance spreads. Therefore, intrusion of the slurry and the dispersion medium or clogging caused by solidification thereof hardly occurs, and the mating ring smoothly follows the seal ring to maintain the functions of the mechanical seal. In addition, the lower portion of the fitting groove to which the O-ring is fitted has a V-shaped cross-section. Since the entire wall is not thin, the strength is maintained, and the O-ring has high holding ability.

In particular, the separator preferably includes two disks having blade-fitting grooves on the inner faces facing each other, a blade fitted to the fitting grooves and lying between the disks, and supporting means supporting the disks having the blade therebetween from both sides. That is, it is preferable that the wet agitating ball mill includes a cylindrical stator, a slurry supplying port disposed at one end of the stator, a slurry discharging port disposed at the other end of the stator, a rotor agitating and mixing the dispersion medium packed in the stator and the slurry supplied from the supplying port, and a rotatable separator provided in the stator, connected to the discharging port, separating the slurry from the dispersion medium by centrifugal force, and discharging the slurry from the discharging port, and that the separator includes two disks having fitting grooves for a blade on the inner faces facing each other, the blade fitted to the fitting grooves and lying between the disks, and supporting means supporting the disks having the blade therebetween from both sides. In such a case, preferably, the supporting means is defined by a shoulder of a shouldered shaft and cylindrical pressing means fitted to the shaft and pressing the disks, and supports the disks having the blade therebetween by pinching them from both sides with the shoulder of the shaft and the pressing means. With such a wet agitating ball mill, the metal oxide particles in the undercoat layer can readily have a volume average particle diameter and a 90% cumulative particle diameter within the aforementioned ranges. Here, the separator preferably has an impeller-type structure.

The structure of the above-described vertical wet agitating ball mill will now be more specifically described with reference to an embodiment of the wet agitating ball mill. However, the agitating apparatus used for producing the coating liquid for an undercoat layer of the present invention is not limited to those exemplified here.

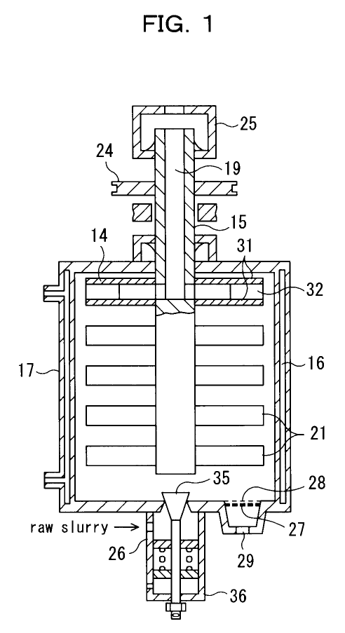

FIG. 1 is a longitudinal cross-sectional view schematically illustrating a structure of a wet agitating ball mill according to this embodiment. In FIG. 1, slurry (not shown) is supplied to the vertical wet agitating ball mill and is agitated with a dispersion medium (not shown) in the mill for pulverization. Then, the slurry is separated from the dispersion medium by a separator 14 and is discharged through a discharging path 19 in the center of a shaft 15 and then is recycled via a return path (not shown) for further milling.

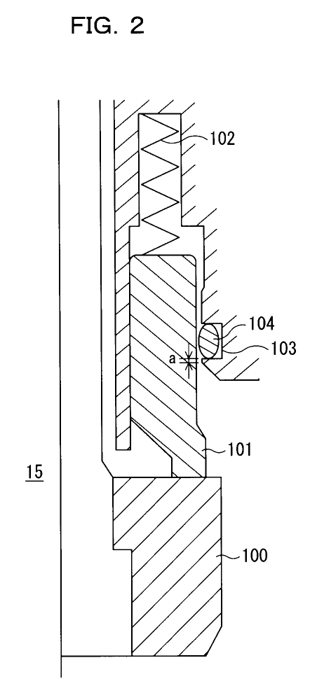

As shown in FIG. 1 in detail, the vertical wet agitating ball mill has a stator 17 provided with a vertically cylindrical jacket 16 that allows a flow of water for cooling the mill; a shaft 15 that is rotatably born on the upper portion of the stator 17 at the center of the stator 17 and has a mechanical seal shown in FIG. 2 (described below) at a bearing portion and has a hollow center as a discharging path 19 at the upper portion; pin- or disk-shaped rotors 21 protruding in the radial direction at the lower portion of the shaft 15; a pulley 24, for transmitting driving force, fixed to the upper portion of the shaft 15; a rotary joint 25 mounted on an open end at the upper end of the shaft 15; a separator 14, for separating the medium, fixed to the shaft 15 near the upper portion in the stator 17; a slurry supplying port 26 disposed to the bottom of the stator 17 so as to oppose to the end of the shaft 15; and a screen 28, for separating the dispersion medium, mounted on a grid screen support 27 that is provided to a slurry outlet 29 disposed at an eccentric position of the bottom of the stator 17.

The separator 14 consists of a pair of disks 31 fixed to the shaft 15 with a predetermined interval and a blade 32 connecting these disks 31 to define an impeller and rotates with the shaft 15 to apply centrifugal force to the dispersion medium and the slurry entrapped between the disks 31 for centrifuging the dispersion medium in the radial direction and discharging the slurry through the discharging path 19 in the center of the shaft 15 by the difference in specific gravity.

The slurry supplying port 26 consists of an inverted trapezoidal valve element 35 that is vertically movable and is fitted to a valve seat disposed at the bottom of the stator 17 and a cylindrical body 36 having a bottom and protruding downward from the bottom of the stator 17. The valve element 35 is lifted upon the supply of slurry to form an annular slit (not shown) with the valve seat, whereby the slurry is supplied to the interior of the stator 17.

When a raw material is supplied, the valve element 35 is lifted by a supply pressure due to the slurry supplied to the inside of the cylindrical body 36, against the pressure in the mill, to form a slit between itself and the valve seat.

In order to prevent clogging of the slit, the valve element 35 repeats moving to the upper limit position within a short cycle so as to prevent from catching. This vibration of the valve element 35 may be constantly performed, or may be performed when a large amount of coarse particles are contained in the slurry or in conjunction with an increase in supply pressure of the slurry due to clogging.

In the mechanical seal, as shown in FIG. 2 in detail, a mating ring 101 at the stator side is clamped by a spring 102 on a seal ring 100 fixed to the shaft 15. The stator 17 and the mating ring 101 are sealed by an O-ring 104 that is fitted to a fitting groove 103 at the stator side. In FIG. 2, a tapered cut (not shown) broadening downward is provided at the lower portion of the O-ring fitting groove 103. The length “a” of minimum clearance between the lower portion of the fitting groove 103 and the mating ring 101 is small in order to prevent deterioration of the sealing between the mating ring 101 and the seal ring 100 due to inhibited motion of the mating ring 101 by solidification of trapped medium or slurry.

In the above embodiment, the rotors 21 and the separator 14 are fixed to the same shaft 15. In another embodiment, however, they are fixed to different shafts coaxially arranged and are independently rotated. In the embodiment shown above, since the rotor and the separator are provided to the same shaft, a single driving apparatus is required, resulting in simplification of the structure. In the latter embodiment, the rotor and the shaft are mounted on the different shafts and are independently rotated by the respective driving apparatuses, and thus the rotor and the separator are independently driven at their optimum rotation rates.

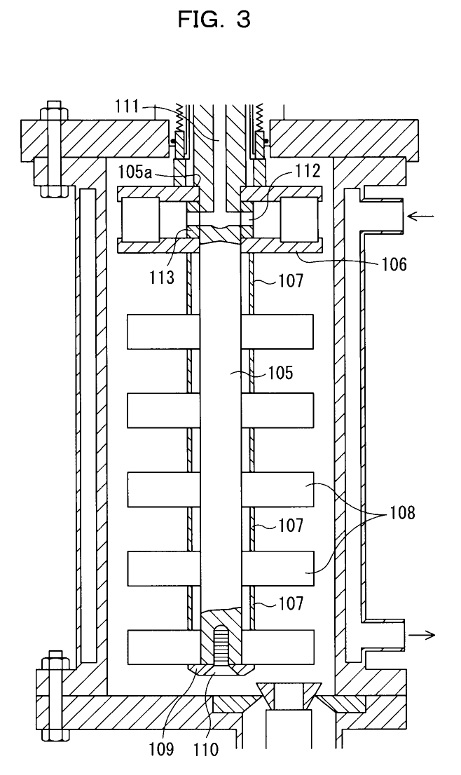

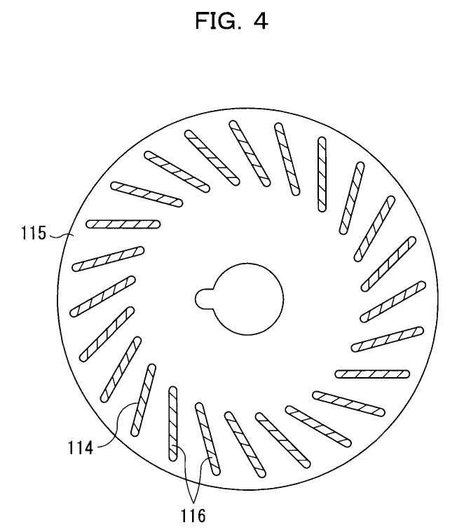

In the ball mill shown in FIG. 3, the shaft 105 is a shouldered shaft. A separator 106 is put on and fitted to the shaft from the lower end of the shaft, then spacers 107 and disk or pin rotors 108 are alternately put on and fitted to the shaft. Then a stopper 109 is fixed to the lower end of the shaft with a screw 110. Thus, the separator 106, the spacers 107, and the rotors 108 are interposed between the shoulder 105a of the shaft 105 and the stopper 109, and fixed in conjunction with each other. The separator 106 includes a pair of disks 115 each provided with blade fitting grooves 114, as shown in FIG. 4, on the inner surfaces facing each other, blades 116 interposing between both the disks and fitted to the blade fitting grooves 114, and an annular spacer 113 for securing a predetermined distance between these disks 115 and having a hole 112 communicating with a discharging path 111 to define an impeller.

An example of the wet agitating ball mill having a structure shown in this embodiment is an Ultra Apex Mill manufactured by Kotobuki Industries Co., Ltd.

Using the wet agitating ball mill of this embodiment having such a structure, slurry is dispersed through the following procedures: A dispersion medium (not shown) is packed in the stator 17 of the wet agitating ball mill of this embodiment, the rotors 21 and the separator 14 are rotated by driving force from an external power source, while a predetermined amount of slurry is supplied from the supplying port 26. As a result, the slurry is supplied to the interior of the stator 7 through the slit (not shown) formed between the edge of the valve seat and the valve element 35.

The slurry and the dispersion medium in the stator 7 are stirred and mixed by the rotation of the rotors 21 to pulverize the slurry. Furthermore, the dispersion medium and the slurry transferred by the rotation of the separator 14 into the separator 14 are separated from each other by the difference in specific gravity. The dispersion medium, which has a larger specific gravity, is centrifuged in the radial direction, and the slurry, which has a smaller specific gravity, is discharged through the discharging path 19 in the center of the shaft 15 toward a raw material tank. When the pulverization proceeds to some extent, the particle size may be optionally measured. If a desired particle size is obtained, the raw material pump is stopped once, and then mill driving is stopped to terminate the pulverization.

When metal oxide particles are dispersed in a wet agitating ball mill, the filling rate of the dispersion medium packed in the wet agitating ball mill is not limited, as long as the metal oxide particles can be dispersed into a predetermined particle size distribution. When metal oxide particles are dispersed in such a vertical wet agitating ball mill described above, the filling rate of the dispersion medium packed in the wet agitating ball mill is usually 50% or more, preferably 70% or more, and more preferably 80% or more and usually 100% or less, preferably 95% or less, and more preferably 90% or less.

The wet agitating ball mill used for dispersing metal oxide particles may have a separator of a screen or slit mechanism, but, as described above, an impeller-type is desirable and a vertical impeller type is preferable. The wet agitating ball mill is desirably of a vertical type having a separator at the upper portion of the mill. In particular, when the filling rate of the dispersion medium is adjusted to the above-mentioned range, pulverization is most efficiently performed, and the separator can be placed at a position higher than the level of the packed medium. This can prevent leakage of a dispersion medium which is carried on the separator.

The operation conditions of the wet agitating ball mill applied to the dispersion of metal oxide particles affect the volume average particle diameter and the 90% cumulative particle diameter of the metal oxide particles in a coating liquid for forming an undercoat layer, the stability of the coating liquid for forming an undercoat layer, the surface shape of the undercoat layer formed by applying the coating liquid for forming an undercoat layer, and characteristics of an electrophotographic photoreceptor having the undercoat layer formed by applying the coating liquid for forming an undercoat layer. In particular, the slurry supplying rate and the rotation velocity of the rotor have significant influences.

The slurry-supplying rate relates to the residence time of the slurry in the wet agitating ball mill. Accordingly, though the rate varies depending on the capacity and shape of the mill, in the case of a stator usually used, the rate is generally 20 kg/hour or more and preferably 30 kg/hour and usually 80 kg/hour or less and preferably 70 kg/hour or less per liter (hereinafter, optionally, abbreviated to L) of the wet agitating ball mill capacity.

The rotation velocity of the rotor is affected by parameters such as the shape of the rotor or the distance from the stator. In the case of a stator and a rotor usually used, the circumferential velocity at the top end of the rotor is usually 5 m/second or more, preferably 8 m/second or more, and more preferably 10 m/second or more and usually 20 m/second or less, preferably 15 m/second or less, and more preferably 12 m/second or less.

Furthermore, the amount of the dispersion medium is not limited. However, the volume ratio of the dispersion medium to slurry is usually 1 to 5. A dispersion aid that can be readily removed after the dispersion may be also used together with the dispersion medium. Examples of the dispersion aid include sodium chloride and mirabilite.

The dispersion of metal oxide particles is preferably carried out by a wet process in the presence of a dispersion solvent. In addition to the dispersion solvent, any additional component may be present as long as the metal oxide particles can be properly dispersed. Examples of such an additional component include a binder resin and various types of additives.

Any dispersion solvent can be used without limitation, but the solvent that is used in the coating liquid for forming an undercoat layer is preferably used because of no requirement of steps, such as exchange of solvent, after the dispersion. These dispersion solvents may be used alone or as a solvent mixture of two or more kinds in any combination and any ratio.

The amount of the dispersion solvent used is in the range of usually 0.1 part by weight or more and preferably 1 part by weight or more and usually 500 parts by weight or less and preferably 100 parts by weight or less, on the basis of 1 part by weight of metal oxide particles to be dispersed, from the viewpoint of productivity.

The mechanical dispersion can be carried out at any temperature from the freezing point to the boiling point of a solvent (or solvent mixture), but is carried out at a temperature of usually 10° C. or higher and usually 200° C. or lower from the viewpoint of safe manufacturing operation.

After the dispersion treatment using a dispersion medium, it is preferable that the dispersion medium be separated and removed from the slurry, and subjected to further sonication. The sonication is a treatment of the metal oxide particles with ultrasonic vibration.

Conditions, such as a vibration frequency, for the sonication are not particularly limited, but ultrasonic vibration with a frequency of usually 10 kHz or more and preferably 15 kHz or more and usually 40 kHz or less and preferably 35 kHz or less from an oscillator is used.

Furthermore, the output of an ultrasonic oscillator is not particularly limited, but is usually 100 W to 5 kW.

In general, dispersion treatment of a small amount of slurry with ultrasound from a low output ultrasonic oscillator is more efficient compared to that of a large amount of slurry with ultrasound from a high output ultrasonic oscillator. Therefore, the amount of slurry to be treated at once is usually 1 L or more, preferably 5 L or more, and more preferably 10 L or more and usually 50 L or less, preferably 30 L or less, and more preferably 20 L or less. The output of an ultrasonic oscillator in such a case is preferably 200 W or more, more preferably 300 W or more, and most preferably 500 W or more and preferably 3 kW or less, more preferably 2 kW or less, and still more preferably 1.5 kW or less.

The method of applying ultrasonic vibration to metal oxide particles is not particularly limited. For example, the treatment is carried out by directly immersing an ultrasonic oscillator in a container containing slurry, bringing an ultrasonic oscillator into contact with the outer wall of a container containing slurry, or immersing a container containing slurry in a liquid to which vibration is applied with an ultrasonic oscillator. Among these methods, preferably used is the method of immersing a container containing slurry in a liquid to which vibration is applied with an ultrasonic oscillator.

In such a case, the liquid to which vibration is applied with an ultrasonic oscillator is not limited, and examples thereof include water; alcohols such as methanol; aromatic hydrocarbons such as toluene; and oils such as a silicone oil. In particular, water is preferred, in consideration of safe manufacturing operation, cost, washing properties, and other factors.

In the method of immersing the container containing slurry in a liquid to which vibration is applied with an ultrasonic oscillator, since the efficiency of the sonication varies depending on the temperature of the liquid, it is preferable to maintain the temperature of the liquid constant. The applied vibration may raise the temperature of the liquid that is subjected to the ultrasonic vibration. The temperature of the liquid subjected to the sonication is in the range of usually 5° C. or higher, preferably 10° C. or higher, and more preferably 15° C. or higher and usually 60° C. or lower, preferably 50° C. or lower, and more preferably 40° C. or lower.

The container for containing the slurry treated with ultrasound is not limited. For example, any container that is usually used for containing a coating liquid for forming an undercoat layer, which is used for forming a photosensitive layer of an electrophotographic photoreceptor, can be also used. Examples of the container include containers made of resins such as polyethylene or polypropylene, glass containers, and metal cans. Among them, metal cans are preferred. In particular, an 18-liter metal can prescribed in JIS Z 1602 is preferred because of its high resistances to organic solvents and impacts.

The slurry after dispersion or after sonication is filtered before use, according to need, in order to remove coarse particles. The filtration medium in such a case may be any filtering material that is usually used for filtration, such as cellulose fiber, resin fiber, or glass fiber. A preferred form of the filtration medium is a so-called winded filter, which is made of a fiber winded around a core material, because it has a large filtration area to achieve high efficiency. Any known core material can be used, and examples thereof include stainless steel core materials and core materials made of resins, such as polypropylene, that are not dissolved in the slurry and the solvent contained in the slurry.

To the resulting slurry, a solvent, a binder resin (binder), and other optional components (e.g., auxiliary agents) are further added to give a coating liquid for forming an undercoat layer. The metal oxide particles may be mixed with the solvent of the coating liquid for forming an undercoat layer, the binder resin, and the other optional components, in any step of before, during, or after the dispersion or sonication process. Therefore, mixing of the metal oxide particles with the solvent, the binder resin, or the other components may not be necessarily carried out after the dispersion or sonication.

As described above, according to the method of preparing the coating liquid for forming an undercoat layer of the present invention, the coating liquid for forming an undercoat layer according to the present invention can be efficiently produced and also can have higher storage stability. Therefore, an electrophotographic photoreceptor with higher quality can be efficiently obtained.

### [III-3. Formation of Undercoat Layer]

The undercoat layer according to the present invention can be formed by applying the coating liquid for forming an undercoat layer according to the present invention onto an electroconductive support and drying it. The method of applying the coating liquid for forming an undercoat layer according to the present invention is not limited, and examples thereof include dip coating, spray coating, nozzle coating, spiral coating, ring coating, bar-coat coating, roll-coat coating, and blade coating. These coating methods may be carried out alone or in any combination of two or more kinds.

Examples of the spray coating include air spray, airless spray, electrostatic air spray, electrostatic airless spray, rotary atomizing electrostatic spray, hot spray, and hot airless spray. In consideration of the fineness of grains for obtaining a uniform thickness and adhesion efficiency, a preferred method is rotary atomizing electrostatic spray disclosed in Japanese Domestic Re-publication (Saikohyo) No. HEI1-805198, that is, continuous conveyance without spacing in the axial direction with rotation of a cylindrical work. This can give an electrophotographic photoreceptor that exhibits high uniformity of thickness of the undercoat layer with overall high adhesion efficiency.

Examples of the spiral coating method include a method using an injection applicator or a curtain applicator, which is disclosed in Japanese Unexamined Patent Application Publication No. SHO52-119651; a method of continuously spraying paint in the form of a line from a small opening, which is disclosed in Japanese Unexamined Patent Application Publication No. HEI1-231966; and a method using a multi-nozzle body, which is disclosed in Japanese Unexamined Patent Application Publication No. HEI3-193161.

In the case of the dip coating, in general, the total solid content in a coating liquid for forming an undercoat layer is in a range of usually 1 weight % or more and preferably 10 weight % or more and usually 50 mass % or less and preferably 35 weight % or less; and the viscosity is in a range of preferably 0.1 cps or more and preferably 100 cps or less, where 1 Cps=1×10⁻³ Pa·s.

After the application, the coating is dried. It is preferable that the drying temperature and time be adjusted so as to achieve necessary and sufficient drying. The drying temperature is in a range of usually 100° C. or higher, preferably 110° C. or higher, and more preferably 115° C. or higher and usually 250° C. or lower, preferably 170° C. or lower, and more preferably 140° C. or lower. The drying method is not limited. For example, a hot air dryer, a steam dryer, an infrared dryer, or far-infrared dryer can be used.

### [IV. Photosensitive Layer]

The photosensitive layer can have any composition that can be applied to a known electrophotographic photoreceptor, and examples thereof include a so-called single-layer photoreceptor having a single photosensitive layer (namely, single photosensitive layer) containing a binder resin dissolving or dispersing a photoconductive material therein; and a so-called multilayered photoreceptor comprised a plurality of laminated layers (laminated photosensitive layer) including a charge-generating layer containing a charge-generating material and a charge-transporting layer containing a charge-transporting material. It is known that the photoconductive material generally exhibits equivalent functions in both the single-type and laminated-type photoreceptors.

The photosensitive layer of the electrophotographic photoreceptor of the present invention may be present in any known form, but is preferably a laminated-type photoreceptor, by taking mechanical physical properties, electric characteristics, manufacturing stability, and other characteristics of the photoreceptor into comprehensive consideration. In particular, a normally laminated-type photoreceptor in which an undercoat layer, a charge-generating layer, and a charge-transporting layer are deposited on an electroconductive support in this order is more preferable.

Furthermore, the photosensitive layer according to the present invention contains a specific arylamine compound.

### [IV-1. Arylamine Compound According to the Present Invention]

The photosensitive layer according to the present invention contains a compound represented by the following Formula (I). The arylamine compound according to the present invention functions as a charge-transporting material in the photosensitive layer.

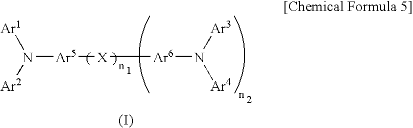

(in Formula (I), Ar¹ to Ar⁶ each independently represent an aromatic moiety that may have a substituent; X represents an organic moiety that may have a substituent; and n₁ and n₂ each independently represent an integer of 0 to 2).

In Formula (I), Ar¹ to Ar⁶ each independently represent an aromatic moiety that may have a substituent. Here, the valences of Ar¹ to Ar⁶ are determined such that the structure represented by Formula (I) can be formed. Specifically, each of Ar¹ to Ar⁴ is univalent, Ar⁵ is univalent or bivalent, and Ar⁶ is bivalent.

Examples of the aromatic moieties Ar¹ to Ar⁶ include moieties of aromatic hydrocarbons such as benzene, naphthalene, anthracene, pyrene, perylene, phenanthrene, and fluorene; and moieties of aromatic heterocycles such as thiophene, pyrrole, carbazole, and imidazole.

In addition, the number of the carbon atoms of the aromatic moieties Ar¹ to Ar⁶ is not limited within a range that does not significantly impair the effects of the present invention, and is usually 20 or less, preferably 16 or less, and more preferably 10 or less. A larger number of carbon atoms may decrease the stability of the arylamine compound represented by Formula (I), resulting in having possibility to decompose by oxidizing gas. Thus, ozone resistance may be decreased. Furthermore, ghosting due to memory may be easy to occur during formation of an image. The lower limit is usually 5 or more and preferably 6 or more, from the viewpoint of electric characteristics.

From the viewpoints described above, among the above-mentioned aromatic moieties, Ar¹ to Ar⁶ are preferably aromatic hydrocarbon moieties, and a benzene moiety is more preferred.

The substituents of Ar¹ to Ar⁶ are not limited as long as the effects of the present invention are not significantly impaired. Examples of the substituent include alkyl groups such as a methyl group, an ethyl group, a propyl group, an isopropyl group, and an allyl group; alkoxy groups such as a methoxy group, an ethoxy group, and a propoxy group; aryl groups such as a phenyl group, an indenyl group, a naphthyl group, an acenaphthyl group, a phenanthryl group, and a pyrenyl group; and heterocyclic groups such as an indolyl group, a quinolyl group, and a carbazolyl group. These substituents may form a ring through a linking group or by a direct bond.

The introduction of the substituent can control intramolecular charge of the arylamine compound according to the present invention to increase charge mobility. However, it may decrease charge mobility by distortion of the intramolecular conjugate plane and intermolecular steric interactions due to the increased molecular volume. Accordingly, the number of the carbon atoms of the substituent is usually 1 or more and usually 6 or less, preferably 4 or less, and more preferably 2 or less.

The number of the substituents may be one or more. In addition, the substituents may be used alone or in any combination of two or more in any ratio. However, introduction of a plurality of substituents is effective for suppressing crystal precipitation of the arylamine compound according to the present invention and is therefore preferred. However, a larger number of the substituents may decrease charge mobility due to intramolecular conjugate distortion and intermolecular steric interactions. Accordingly, the number of the substituents of each Ar¹ to Ar⁶ is usually 2 or less per ring.

Furthermore, it is preferable that the substituents of Ar¹ to Ar⁶ each have small bulkiness for improving stability of the arylamine compound according to the present invention in a photosensitive layer and for improving electric characteristics. From these viewpoints, examples of the substituents of Ar¹ to Ar⁶ are preferably a methyl group, an ethyl group, a butyl group, an isopropyl group, and a methoxy group.

In particular, when Ar¹ to Ar⁴ are benzene moieties, they preferably have substituents at p-positions with respect to the nitrogen atoms. In such a case, examples of the substituent are preferably alkyl groups, and a methyl group is particularly preferred. When Ar⁵ or Ar⁶ is a benzene moiety, preferred substituents are a methyl group and a methoxy group.

In particular, in Formula (I), at least one of Ar¹ to Ar⁴ preferably has a fluorene structure. In such a case, the fluorene structure may be present at least as a partial skeleton. With this, the resulting electrophotographic photoreceptor can exhibit high charge mobility, quick response, and low residual potential.

In Formula (I), X represents an organic moiety that may have a substituent. Here, X has a valence so that the structure represented by Formula (I) can be formed. Specifically, the valence is bivalent or tervalent. In Formula (I), when n₁ is 2 (namely, two X exist), the X may be the same or different from each other.

Examples of the organic moiety represented by X include aromatic moieties; saturated aliphatic moieties; heterocyclic moieties; and organic moieties having, for example, ether structures or divinyl structures.

The number of the carbon atoms in the organic moiety X is not limited within a range that does not significantly impair the effects of the present invention, and is usually 1 or more and 15 or less. In particular, X is preferably an aromatic moiety or a saturated aliphatic moiety. When X is an aromatic moiety, the number of the carbon atoms of the aromatic moiety is preferably 6 or more and preferably 14 or less and more preferably 10 or less. More specifically, arylene groups such as a phenylene group and a naphthylene group are preferred. When X is a saturated aliphatic moiety, the number of the carbon atoms in the saturated aliphatic moiety is preferably 10 or less and more preferably 8 or less.

X may have any substituent that does not significantly impair the effects of the present invention. Examples of the substituent include alkyl groups such as a methyl group, an ethyl group, a propyl group, an isopropyl group, and an allyl group; alkoxy groups such as a methoxy group, an ethoxy group, and a propoxy group; aryl groups such as a phenyl group, an indenyl group, a naphthyl group, an acenaphthyl group, a phenanthryl group, and a pyrenyl group; arylene groups such as a phenylene group and a naphthylene group; and heterocyclic groups such as an indolyl group, a quinolyl group, and a carbazolyl group. Among them, aryl groups, in particular, a phenyl group is preferred. Such substituents can improve electronic characteristics of the resulting photoreceptor. Furthermore, in order to accelerate the charge mobility, alkyl groups, in particular, a methyl group and an ethyl group are preferred. Furthermore, these substituents may form a ring through a linking group or by a direct bond.

The number of the carbon atoms of the substituent of X is not limited as long as the effects of the present invention are not significantly impaired, and is usually 1 or more and usually 10 or less, preferably 6 or less, and more preferably 3 or less. From this view point, preferable examples of the substituent of X include a methyl group, an ethyl group, a butyl group, an isopropyl group, and a methoxy group.

X may have one or more substituents. In addition, the substituents may be used alone or in any combination of two or more kinds in any ratio. A plurality of substituents is preferred because it is effective for suppressing crystal precipitation of the arylamine compound according to the present invention. However, a larger number of substituents may decrease charge mobility due to distortion of the intramolecular conjugate plane and intermolecular steric interactions. Accordingly, the number of the substituents of X is preferably 2 or less per ring.

In Formula (I), n₁ and n₂ each independently represent an integer of 0 to 2. When n₁ is 0, X represents a direct bond. When n₂ is 0, n₁ is preferably 0.

In particular, when both n₁ and n₂ are 1, X preferably represents an alkylidene group or an arylene group. Examples of the alkylidene group preferably include phenylmethylidene, 2-methylpropylidene, 2-methylbutylidene, and cyclohexylidene. Examples of the arylene group preferably include a phenylene group and a naphthylene group.

In addition, when n₂ is 1, X is preferably an alkylidene group in either case of n₁ being 1 or 2. This increases memory resistance of a photoreceptor and hardly causes ghosting in an image formed.

When both n₁ and n₂ are 0, Ar¹ is preferably a benzene moiety or a fluorene moiety, more preferably a tolyl group, a xylyl group, or a fluorenyl group, and further preferably a p-tolyl group or a 2-fluorenyl group.

When n₂ is 2, X is preferably a benzene moiety.

Examples of X having an ether structure include —O—CH₂—O—.

Furthermore, the examples of Ar¹ to Ar⁶ and X described as preferable ones in combinations with n₁ and n₂ may each have the above-mentioned substituent.

Examples of the arylamine compound according to the present invention are shown below. In the following examples of the arylamine compound, R each independently represent a hydrogen atom or any substituent. Examples of the substituent preferably include organic groups such as alkyl groups, alkoxy groups, and phenyl groups, and particularly preferred is a methyl group. Furthermore, n represents an integer of 0 to 2.

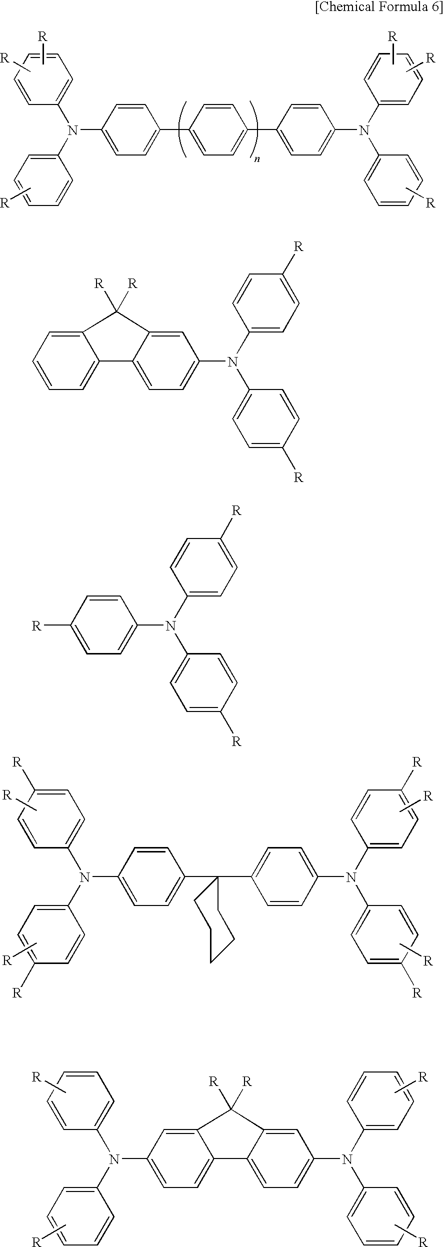

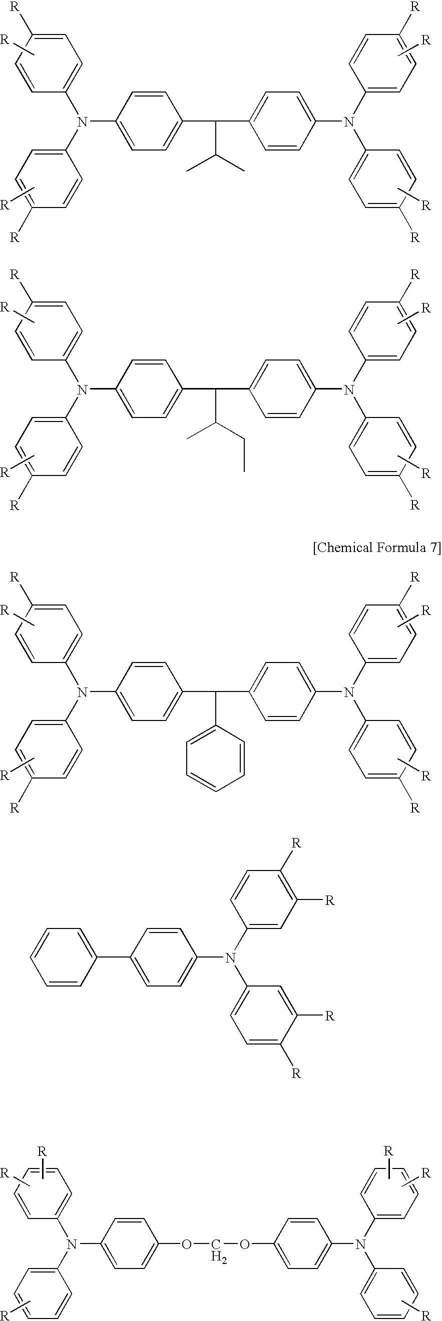

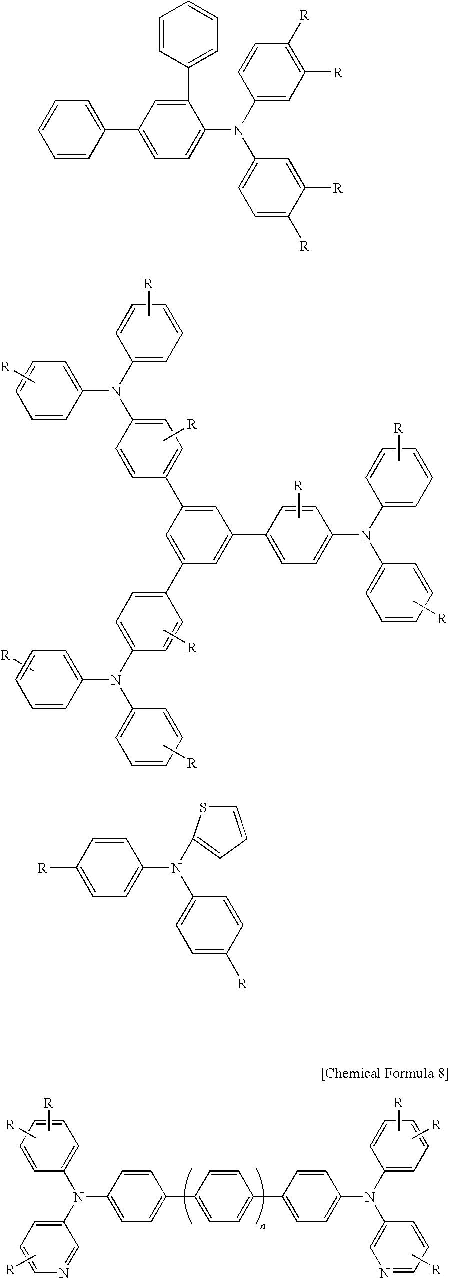

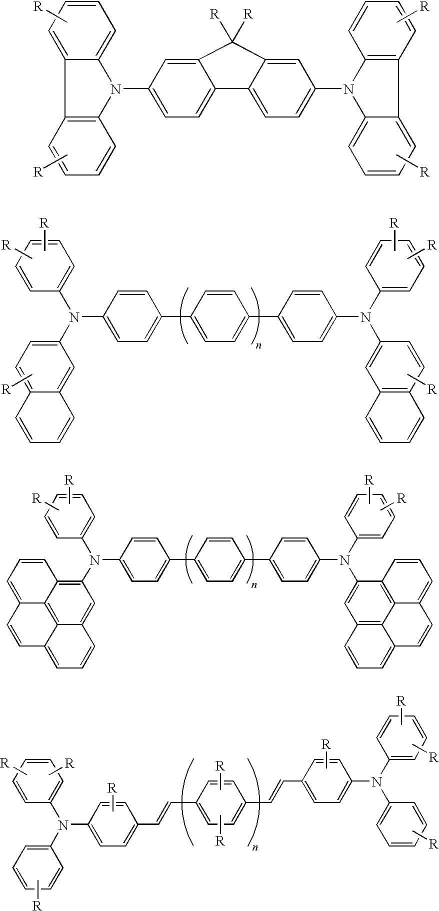

### [IV-2. Charge-Generating Layer]

The charge-generating layer contains a charge-generating material. The charge-generating material can be any known charge-generating material that does not significantly impair the effects of the present invention.

Examples of the charge-generating material are various types of photoconductive materials including inorganic photoconductive materials such as selenium and alloys thereof and cadmium sulfide; and organic pigments such as phthalocyanine pigments, azo pigments, dithioketopyrrolopyrrole pigments, squalene (squalilium) pigments, quinacridone pigments, indigo pigments, perylene pigments, polycyclic quinone pigments, anthanthrone pigments, and benzimidazole pigments. Among them, preferred are the organic pigments, and particularly preferred are phthalocyanine pigments and azo pigments.

Among them, examples of the phthalocyanine pigments include various crystal forms of metal-free phthalocyanine and phthalocyanines with which metals such as copper, indium, gallium, tin, titanium, zinc, vanadium, silicon, and germanium, or oxides thereof, halides thereof, hydroxides thereof, or alkoxides thereof are coordinated. In particular, preferred are crystal forms with high-sensitivity, e.g., metal-free phthalocyanines of X-type and τ-type, titanyl phthalocyanine (alias: oxytitanium phthalocyanine) such as A-type (alias: β-type), B-type (alias: α-type), and D-type (alias: Y-type), vanadyl phthalocyanine, chloroindium phthalocyanine, chlorogallium phthalocyanine such as II-type, hydroxygallium phthalocyanine such as V-type, μ-oxo-gallium phthalocyanine dimer such as G-type and I-type, and μ-oxo-aluminum phthalocyanine dimer such as II-type. Among these phthalocyanine pigments, particularly preferred are A-type (β-type), B-type α-type), D-type (Y-type) oxytitanium phthalocyanine, II-type chlorogallium phthalocyanine, V-type hydroxygallium phthalocyanine, and G-type μ-oxo-gallium phthalocyanine dimer.

In particular, an oxytitanium phthalocyanine showing a distinct main diffraction peak at a Bragg angle (2θ+0.2°) of 27.3° in a powder X-ray diffraction spectrum to CuKα characteristic X-rays is preferred.

The powder X-ray diffraction spectrum to CuKα characteristic X-rays can be measured by usual X-ray diffractometry of solid powder.

Preferably, the oxytitanium phthalocyanine further shows another distinct diffraction peak at a Bragg angle (2θ±0.2°) of 9.0° to 9.8° in the powder X-ray diffraction spectrum to CuKα characteristic X-rays.

Specifically, oxytitanium phthalocyanine having peaks at Bragg angles (2θ±0.2°) of, for example, 9.0°, 9.6°, or 9.5° and 9.7° is preferred. That is, the oxytitanium phthalocyanine preferably shows a distinct main diffraction peak at a Bragg angle (2θ±0.2°) of 9.0°, a distinct diffraction peak at a Bragg angle (2θ±0.2°) of 9.6°, or distinct diffraction peaks at Bragg angles (2θ±0.2°) of 9.5° and 9.7°, in the powder X-ray diffraction spectrum to CuKα characteristic X-rays.

However, the oxytitanium phthalocyanine preferably does not show a distinct diffraction peak at a Bragg angle (2θ±0.2°) of 26.3°.

In the oxytitanium phthalocyanine, the content of chlorine in the crystal is preferably 1.5 weight % or less. The chlorine content can be determined by elemental analysis.

Furthermore, in the oxytitanium phthalocyanine crystal, the ratio of chlorinated oxytitanium phthalocyanine represented by the following formula (1) to unsubstituted oxytitanium phthalocyanine represented by the following formula (2) is usually 0.070 or less, preferably 0.060 or less, and more preferably 0.055 or less, on the basis of the intensity of mass spectra. In addition, in the manufacturing process, the ratio is preferably 0.02 or more for the dry milling method for forming an amorphous form or is preferably 0.03 or less for the acid-paste method for forming an amorphous form. The amount of substituted chlorine can be measured according to the procedure described in Japanese Unexamined Patent Application Publication No. 2001-115054.

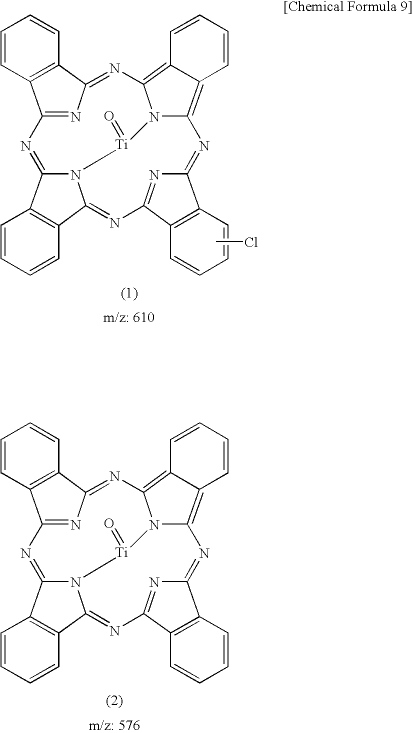

The particle diameter of the oxytitanium phthalocyanine significantly varies depending on its production process, crystal formation, and other conditions, and is preferably 500 nm or less in consideration of dispersibility and is preferably 300 nm or less in consideration of coating characteristics for forming a film.

The oxytitanium phthalocyanine may be substituted with a substituent, such as a fluorine atom, a nitro group, or a cyano group, other than chlorine atom. Furthermore, the oxytitanium phthalocyanines may contain various types of oxytitanium phthalocyanine derivatives having substituents such as a sulfone group.

The oxytitanium phthalocyanine may be produced by any process without limitation. For example, dichlorotitanium phthalocyanine is synthesized with phthalonitrile and titanium halide as raw materials; the dichlorotitanium phthalocyanine is hydrolyzed into an oxytitanium phthalocyanine composition intermediate, followed by purification; the resulting oxytitanium phthalocyanine composition intermediate is converted into an amorphous oxytitanium phthalocyanine composition, which is then crystallized (crystal conversion) in a solvent.

This production process will now be described.

The titanium halide may be any halide that can give oxytitanium phthalocyanine, and titanium chloride is particularly preferred. Examples of titanium chloride include titanium tetrachloride and titanium trichloride, and particularly preferred is titanium tetrachloride. Use of titanium tetrachloride can lead to ready control of the content of chlorinated oxytitanium phthalocyanine in the resulting oxytitanium phthalocyanine composition.

In addition, the titanium halides may be used alone or in any combination of two or more kinds in any ratio.

The synthesis of dichlorotitanium phthalocyanine from phthalonitrile and titanium halide as raw materials may be carried out at any reaction temperature within the range that the reaction proceeds, and is carried out usually at 150° C. or higher and preferably at 180° C. or higher. In the case that the titanium halide is titanium chloride, the reaction temperature is more preferably 190° C. or higher and usually 300° C. or lower, preferably 250° C. or lower, and more preferably 230° C. or lower, in order to control the content of chlorinated oxytitanium phthalocyanine.

In general, titanium chloride is mixed with a mixture of phthalonitrile and a reaction solvent. In such a case, titanium chloride may be directly mixed with the mixture at a temperature equal to or not higher than the boiling point thereof or may be mixed with the mixture after being mixed with a solvent having a high boiling point of 150° C. or higher.

For example, in the case that phthalonitrile and titanium tetrachloride are used for producing oxytitanium phthalocyanine in diarylalkane as a reaction solvent, titanium tetrachloride is partly mixed with phthalonitrile at a low temperature of 100° C. or lower and at a high temperature of 180° C. or higher. With this, oxytitanium phthalocyanine can be appropriately produced.

The resulting dichlorotitanium phthalocyanine is heated and hydrolyzed, and the oxytitanium phthalocyanine composition intermediate obtained after purification is converted into an amorphous form. The amorphous form may be obtained by any method, for example, by pulverization with a known mechanical pulverizer such as a paint shaker, a ball mill, or a sand grind mill; or by a so-called acid-paste method involving dissolution of the intermediate in concentrated sulfuric acid and then solidification of it in cold water. The mechanical pulverization is preferred from the viewpoint of dark decay, while the acid-paste method is preferred from the viewpoint of sensitivity and environmental dependence.

A composition containing oxytitanium phthalocyanine (oxytitanium phthalocyanine composition) is obtained by crystallizing the resulting amorphous oxytitanium phthalocyanine composition using a known solvent. Examples of the solvent preferably used in this step include halogenated aromatic hydrocarbon solvents such as ortho-dichlorobenzene, chlorobenzene, and chloronaphthalene; halogenated hydrocarbon solvents such as chloroform and dichloroethane; aromatic hydrocarbon solvents such as methylnaphthalene, toluene, and xylene; ester-based solvents such as ethyl acetate and butyl acetate; ketone solvents such as methyl ethyl ketone and acetone; alcohols such as methanol, ethanol, butanol, and propanol; ether-based solvents such as ethyl ether, propyl ether, and butyl ether; monoterpene-type hydrocarbon solvents such as terpinolene and pinene; and fluid paraffin. Among them, for example, ortho-dichlorobenzene, toluene, methylnaphthalene, ethyl acetate, butyl ether, and pinene are preferred.

The solvents for crystallization may be used alone or in any combination of two or more kinds in any ratio.

The aforementioned phthalocyanine pigment may be of a mixed crystal state. Here, the phthalocyanine pigment or the mixed crystal state thereof may be obtained by mixing respective constituents afterwards or by causing the mixed state in any production and treatment process of the phthalocyanine pigment, such as synthesis, pigment formation, or crystallization. Examples of such treatment are acid-paste treatment, milling treatment, and solvent treatment. To cause a mixed crystal state, for example, as described in Japanese Unexamined Patent Application Publication No. HEI10-48859, two different crystals are mixed and are then mechanically milled into an amorphous state, and then the mixture is converted into a specific crystal state by solvent treatment.

Examples of the azo pigments preferably include a variety of known bisazo pigments and trisazo pigments.

Preferable examples of the azo pigments are shown below. In the following structural formulae, Cp¹, Cp², and Cp³ each independently represent a coupler.

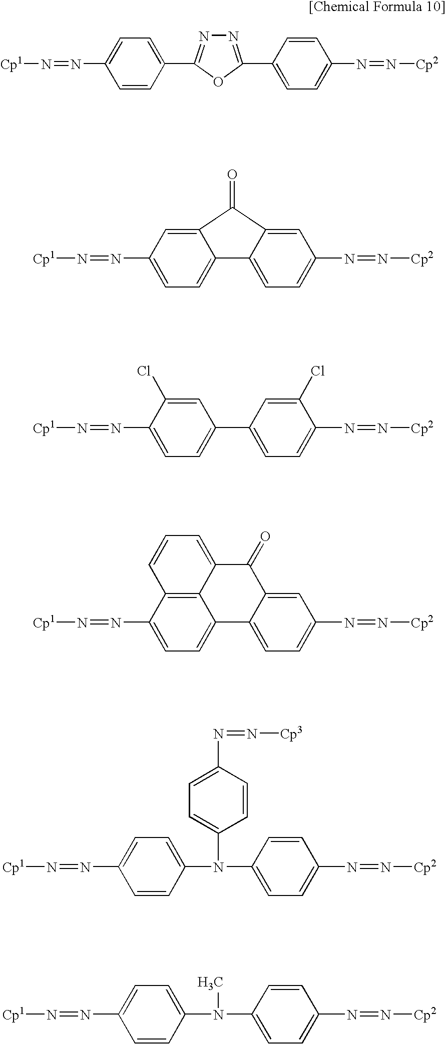

The couplers, Cp¹, Cp², and Cp³, preferably have the following structures:

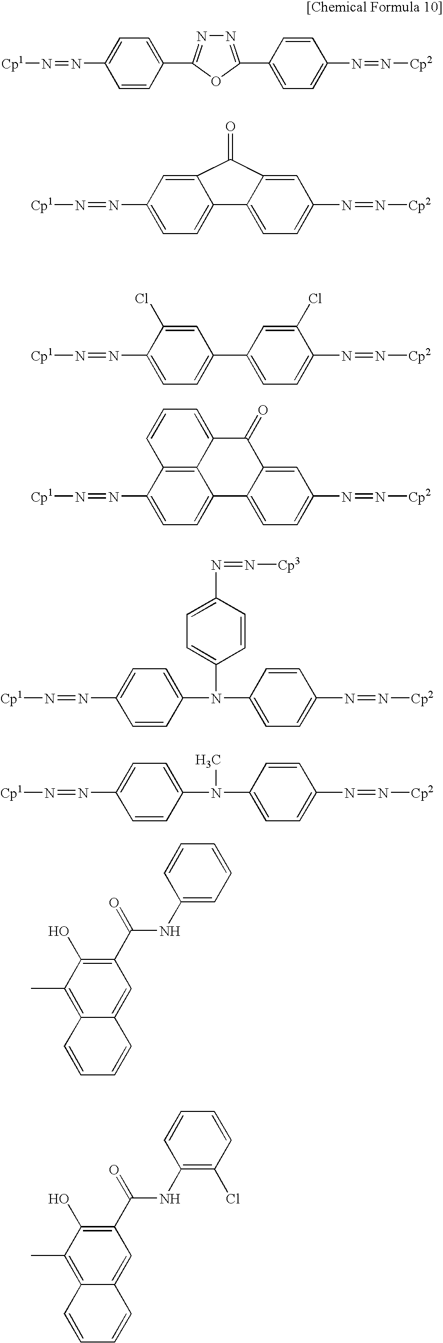

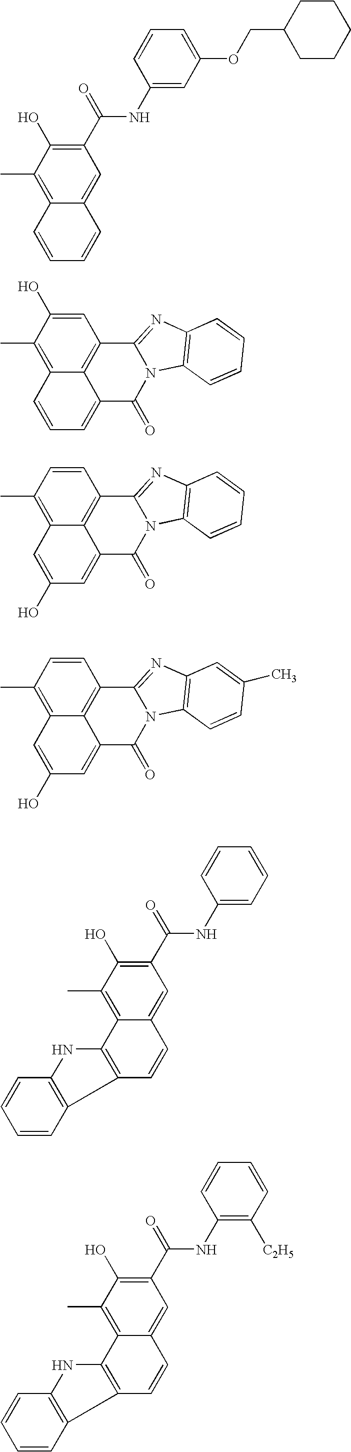

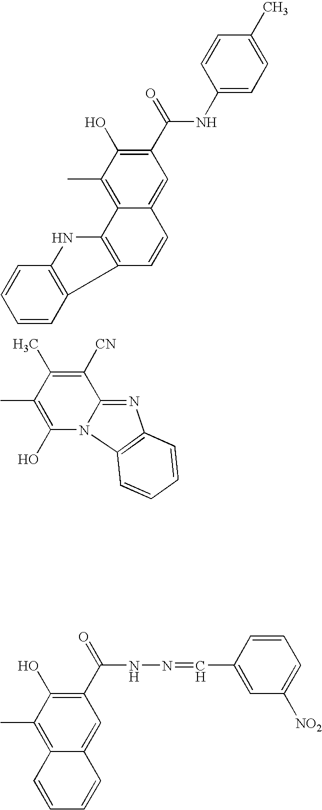

The charge-generating materials may be used alone or in any combination of two or more kinds in any ratio.

In a charge-generating layer, the charge-generating material forms the charge-generating layer in a state of being bound with a binder resin. Any binder resin can be used in the charge-generating layer as long as it does not significantly impair the effects the present invention.

Examples of the binder resin that can be used in the charge-generating layer include insulating resins such as a polyvinyl butyral resin, a polyvinyl formal resin, polyvinyl acetal-based resins, e.g., partially acetal-modified polyvinyl butyral resins in which the butyral groups are partially modified with, for example, formal or acetal, a polyarylate resin, a polycarbonate resin, a polyester resin, an ether-modified polyester resin, a phenoxy resin, a polyvinyl chloride resin, a polyvinylidene chloride resin, a polyvinyl acetate resin, a polystyrene resin, an acrylic resin, a methacrylic resin, a polyacrylamide resin, a polyamide resin, a polyvinyl pyridine resin, a cellulose-based resin, a polyurethane resin, an epoxy resin, a silicone resin, a polyvinyl alcohol resin, a polyvinyl pyrrolidone resin, casein, vinyl chloride-vinyl acetate-based copolymers, e.g., a vinyl chloride-vinyl acetate copolymer, a hydroxyl-modified vinyl chloride-vinyl acetate copolymer, a carboxyl-modified vinyl chloride-vinyl acetate copolymer, and a vinyl chloride-vinyl acetate-maleic anhydride copolymer, a styrene-butadiene copolymer, a polyvinylidene chloride-acrylonitrile copolymer, a styrene-alkyd resin, a silicone-alkyd resin, and a phenol-formaldehyde resin; and organic photoconductive polymers such as poly-N-vinylcarbazole, polyvinylanthracene, and polyvinylperylene.

In the charge-generating layer, the binder resins may be used alone or in any combination of two or more in any ratio.

The amount of the charge-generating material used is optional within a range that does not significantly impair the effects of the present invention, and is usually 10 parts by weight or more and preferably 30 parts by weight or more and usually 1000 parts by weight or less and preferably 500 parts by weight or less, on the basis of 100 parts by weight of the binder resin in the charge-generating layer. A smaller amount of the charge-generating material may not realize sufficient sensitivity, and a larger amount may cause agglomeration of the charge-generating material to decrease the stability of the coating liquid that is used for forming a charge-generating layer.

The thickness of the charge-generating layer is not limited, but is usually 0.1 μm or more and preferably 0.15 μm or more and usually 4 μm or less and preferably 0.6 μm or less.

The charge-generating material is dispersed in a coating liquid for forming a photosensitive layer when it is formed, and the method for the dispersion is not limited. For example, ultrasonic dispersion, ball-mill dispersion, attritor dispersion, or sand-mill dispersion is employed. In this process, it is effective for the dispersion to reduce the particle diameter of the charge-generating material to usually 0.5 μm or less, preferably 0.3 μm or less, and more preferably 0.15 μm or less.

Furthermore, the charge-generating layer may further contain an additional component that does not significantly impair the effects of the present invention. For example, the charge-generating layer may contain any additive. The additive is used for improving film-forming characteristics, flexibility, coating characteristics, contamination resistance, gas stability, light stability, or other characteristics. Examples of the additive include an antioxidant, a plasticizer, an ultraviolet absorber, an electron-attractive compound, a leveling agent, a visible light-shielding agent, a sensitizer, a dye, a pigment, and a surfactant. Examples of the antioxidant include hindered phenol compounds and hindered amine compounds. Examples of the dye and the pigment include various types of coloring compounds and azo compounds. Examples of the surfactant include silicone oils and fluorine-based oils.

The additives may be used alone or in any combination of two or more kinds in any ratio.

### [IV-3. Charge-Transporting Layer]

The charge-transporting layer contains a charge-transporting material. In the electrophotographic photoreceptor of the present invention, the charge-transporting material is an arylamine compound according to the present invention.

In addition, a charge-generating [SIC] material other than the arylamine compound according to the present invention (hereinafter, optionally, referred to as “charge-transporting material that can be used together”) can be used together with the arylamine compound according to the present invention as long as it does not significantly impair the effects of the present invention.

Examples of charge-transporting materials that can be used together include aromatic nitro compounds such as 2,4,7-trinitrofluorenone; cyano compounds such as tetracyanoquinodimethane; electron-attractive materials, for example, quinone compounds such as diphenoquinone; heterocyclic compounds such as carbazole derivatives, indol derivatives, imidazole derivatives, oxazole derivatives, pyrazole derivatives, thiadiazole derivatives, and benzofuran derivatives; aniline derivatives, hydrazone derivatives, aromatic amine derivatives, stilbene derivatives, butadiene derivatives, enamine derivatives, and products in which some of these compounds are bonded to each other; and electron-donating materials such as polymers having groups composed of these compounds in their main chains or side chains. Among them, carbazole derivatives, aromatic amine derivatives, stilbene derivatives, butadiene derivatives, enamine derivatives, and products in which some of these compounds are bonded to each other are preferable.

Specific examples of the preferable structures of the charge-transporting material that can be used together are shown below. These examples are merely shown for illustrative purposes, and the charge-transporting material that can be used together is not limited to the examples shown below and any known charge-transporting material may also be used within the scope of the present invention.

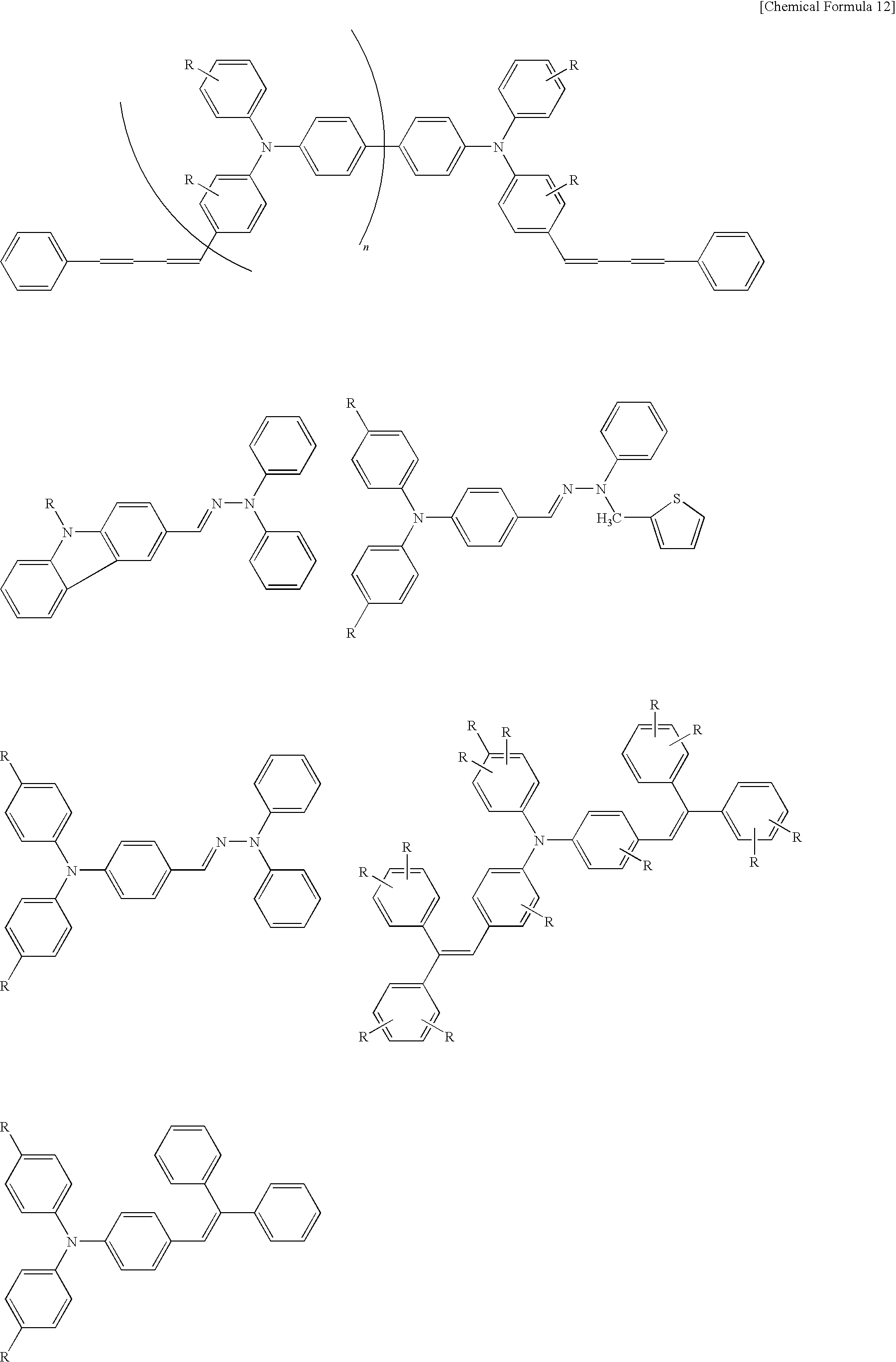

In the structural formulae of the charge-transporting materials that can be used together shown above, R represents a hydrogen atom or a substituent. This substituent is preferably an organic group such as an alkyl group, an alkoxy group, or a phenyl group. Particularly preferred is a methyl group. Furthermore, n represents an integer of 0 to 2. R may be the same or different from each other.

The charge-transporting materials may be used alone or in any combination of two or more kinds in any ratio. Accordingly, the arylamine compounds according to the present invention may be used alone or in any combination of two or more kinds in any ratio. Furthermore, the charge-transporting materials that can be used together may be alone or in any combination of two or more kinds in any ratio.

When a charge-generating [SIC] material that can be used together is used, the amount of the arylamine compound according to the present invention relative to that of the total charge-generating [SIC] materials is not limited within a range that does not significantly impair the effects of the present invention, and is usually 60 weight % or more, preferably 80 weight % or more, and more preferably 90 weight % or more. A smaller amount of the arylamine compound according to the present invention may decrease memory resistance of a photoreceptor, resulting in ready ghosting. The upper limit is 100 weight %.

In the charge-transporting layer, the charge-transporting material is bound with a binder resin. The binder resin is used to ensure the strength of the layer.

Examples of the binder resin used in the charge-generating [SIC] layer include butadiene resins, styrene resins, vinyl acetate resins, vinyl chloride resins, acrylic acid ester resins, methacrylic acid ester resins, vinyl alcohol resins, polymers and copolymers of vinyl compounds such as ethyl vinyl ether, polyvinyl butyral resins, polyvinyl formal resins, partially modified polyvinyl acetal, polycarbonate resins, polyester resins, polyarylate resins, polyamide resins, polyurethane resins, cellulose ester resins, phenoxy resins, silicone resins, silicone-alkyd resins, and poly-N-vinylcarbazole resins. These binder resins may be modified with a silicon reagent or any other reagent.

Among the above-mentioned binder resins, the polycarbonate resins and the polyarylate resins are particularly preferred. Furthermore, among the polycarbonate resins and the polyarylate resins, polycarbonate resins and polyarylate resins containing a bisphenol component or a biphenol component having a structure shown below are preferred from the viewpoints of sensitivity and residual potential. In particular, the polycarbonate resins are more preferred from the viewpoint of mobility.

The structures of monomers corresponding to the bisphenol component and the biphenol component that can be suitably used in the polycarbonate resins are shown below. However, these are merely exemplified for clarifying the concept, and accordingly the present invention is not limited to the structures shown below within the scope of the present invention.

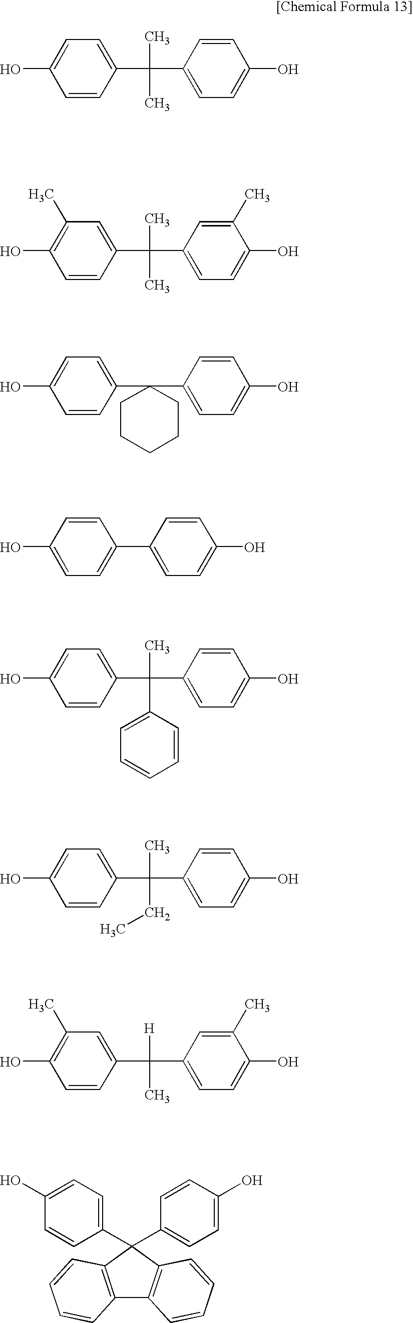

In particular, in order to achieve higher effects of the present invention, preferred are polycarbonate resins containing bisphenol components corresponding to the bisphenol derivatives shown by the following structures:

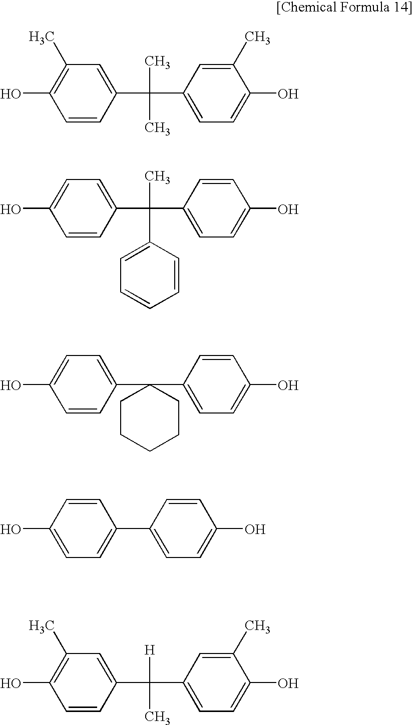

Furthermore, in order to improve mechanical characteristics, it is preferable to use a polyarylate resin. In such a case, preferred are bisphenol components corresponding to monomers represented by the following structural formulae:

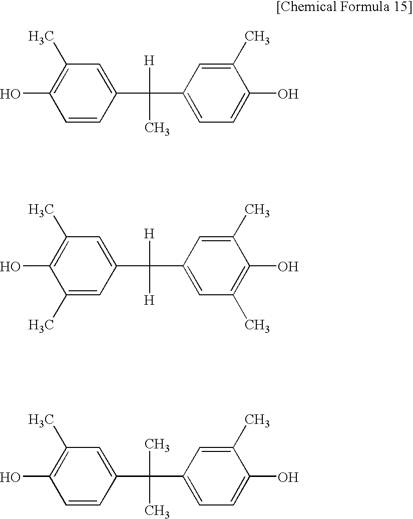

Furthermore, preferred acid components correspond to monomers represented by the following formulae:

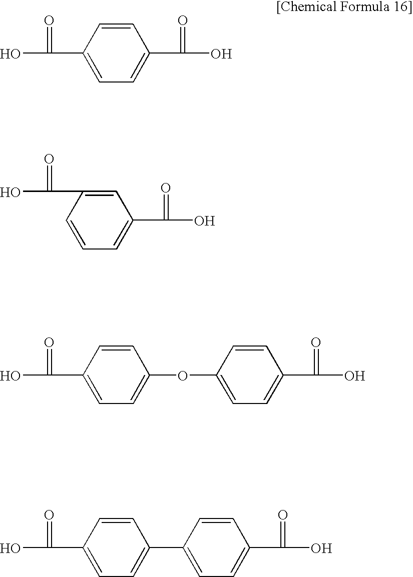

In the charge-transporting layer, the binder resins may be used alone or in any combination of two or more kinds in any ratio.

The ratio of the charge-transporting material and the binder resin used in the charge-transporting layer is optional within a range that does not significantly impair the effects of the present invention, and the amount of the charge-transporting material is usually 20 parts by weight or more, preferably 30 parts by weight or more from the viewpoint of a decrease in residual potential, and more preferably 40 parts by weight or more from the viewpoints of stability in repeated use and charge mobility, on the basis of 100 parts by weight of the binder resin. On the other hand, the amount is usually 150 parts by weight or less from the viewpoint of thermal stability of the photosensitive layer, more preferably 120 parts by weight or less from the viewpoint of compatibility between the charge-transporting material and the binder resin, more preferably 100 parts by weight or less from the viewpoint of printing durability, and still more preferably 80 parts by weight or less from the viewpoint of scratch resistance.

Furthermore, the thickness of the charge-transporting layer is not limited, but is usually 5 μm or more and preferably 10 μm or more from the viewpoints of a long service life and image stability, and usually 50 μm or less, preferably 45 μm or less from the viewpoints of a long service life and image stability, and more preferably 30 μm or less from the viewpoint of high resolution.

Furthermore, the charge-generating layer may contain any component, for example, any additive that does not significantly impair the effects of the present invention, as in the charge-transporting layer.

### [IV-4. Single Photosensitive Layer]

A single photosensitive layer is comprised of the charge-generating material dispersed in a charge-transporting layer having the blending ratio mentioned above.

In the single photosensitive layer, the types and the ratio of the charge-transporting material and the binder resin are the same as those described in the charge-transporting layer. Therefore, the single photosensitive layer contains the arylamine compound according to the present invention.

Furthermore, the charge-generating material is the same types as those described above. However, in this case, it is desirable that the particle diameter of the charge-generating material be sufficiently small. Specifically, the particle diameter is usually 0.5 μm or less, preferably 0.3 μm or less, and more preferably 0.15 μm or less.

Furthermore, a smaller amount of the charge-generating material dispersed in the photosensitive layer may cause insufficient sensitivity, and a larger amount may cause a decrease in charging performance and a decrease in sensitivity. Accordingly, the amount of the charge-generating material in the single photosensitive layer is usually 0.1 weight % or more and more preferably 1 weight % or more and usually 50 weight % or less and preferably 20 weight % or less.

The thickness of the single photosensitive layer is not limited, but is usually 5 μm or more and preferably 10 μm or more and usually 100 μm or less and more preferably 50 μm or less.

Furthermore, the single photosensitive layer may also contain any component that does not significantly impair the effects of the present invention. For example, this layer may contain additives, like the charge-generating layer.

### [IV-5. Method for Forming Photosensitive Layer]

Each layer (charge-generating layer, charge-transporting layer, or single photosensitive layer) constituting a photosensitive layer may be formed by any method without limitation, but, usually, these layers are formed in series by repeating the coating and drying steps of coating liquids each containing materials constituting each layer (coating liquid for a charge-generating layer, coating liquid for a charge-transporting layer, and coating liquid for a single photosensitive layer) onto an undercoat layer by a known method.

For example, the charge-generating layer can be formed by preparing a coating liquid by dissolving or dispersing a charge-generating material, a binder resin, and other components in a solvent; applying this coating liquid onto an undercoat layer in the case of a normally laminated photosensitive layer or onto a charge-transporting layer in the case of a reversely laminated photosensitive layer; and drying the liquid.

The charge-transporting layer can be formed by preparing a coating liquid by dissolving or dispersing a charge-transporting material, a binder resin, and other components in a solvent; applying this coating liquid onto the charge-generating layer in the case of a normally laminated photosensitive layer or onto the undercoat layer in the case of a reversely laminated photosensitive layer; and drying the liquid.

Furthermore, the single photosensitive layer can be formed by preparing a coating liquid by dissolving or dispersing a charge-generating material, a charge-transporting material, a binder resin, and other components in a solvent; applying this coating liquid onto an undercoat layer; and drying the liquid.

The solvent (or dispersion medium) used for dissolving the binder resin in the preparation of the coating liquid is not limited as long as the effects of the present invention are not significantly impaired. Examples of the solvent include saturated aliphatic solvents such as pentane, hexane, octane, and nonane; aromatic solvents such as toluene, xylene, and anisole; halogenated aromatic solvents such as chlorobenzene, dichlorobenzene, and chloronaphthalene; amide solvents such as dimethylformamide and N-methyl-2-pyrrolidone; alcohol solvents such as methanol, ethanol, isopropanol, n-butanol, and benzyl alcohol; aliphatic polyols such as glycerin and ethylene glycol; chained, branched, or cyclic ketone solvents such as acetone, cyclohexanone, methyl ethyl ketone, and 4-methoxy-4-methyl-2-pentanone; ester solvents such as methyl formate, ethyl acetate, and n-butyl acetate; halogenated hydrocarbon solvents such as methylene chloride, chloroform, and 1,2-dichloroethane; chainedor cyclic ether solvents such as diethyl ether, dimethoxy ethane, tetrahydrofuran, 1,4-dioxane, methyl cellosolve, and ethyl cellosolve; aprotic polar solvents such as acetonitrile, dimethyl sulfoxide, sulforane, and hexamethyl phosphate triamide; nitrogen-containing compounds such as n-butylamine, isopropanolamine, diethylamine, triethanolamine, ethylenediamine, and triethylamine; mineral oils such as ligroin; and water. Among them, those that do not dissolve the undercoat layer are preferable.

In addition, these solvents may be used alone or in any combination of two or more kinds in any ratio.

The solid content, in the case of the coating liquid for a single-layer photoreceptor or a charge-transporting layer, is usually 5 weight % or more and preferably 10 weight % or more and usually 40 weight % or less and preferably 35 weight % or less. In addition, the viscosity of these coating liquids is usually 10 mPa·s or more and preferably 50 mPa·s or more and usually 500 mPa·s or less and preferably 400 mPa·s or less.

On the other hand, in the case of the coating liquid for a charge-generating layer, the solid content is usually 0.1 weight % or more and preferably 1 weight % or more and usually 15 weight % or less and preferably 10 weight % or less. In addition, the viscosity of this coating liquid is usually 0.01 mPa·s or more and preferably 0.1 mPa·s or more and usually 20 mPa·s or less and preferably 10 mPa·s or less.

The coating liquid may be applied by any method, for example, dip coating, spray coating, spin coating, bead coating, wire-bar coating, blade coating, roller coating, air-knife coating, curtain coating, or any other known coating method.

The coating liquid may be dried by any method, and is preferably dried by contact drying at room temperature and then heat drying at a temperature ranging from 30 to 200° C. for 1 minute to 2 hours with or without ventilation. The heating temperature may be constant or variable during the drying process.

### [V. Other Layers]

The electrophotographic photoreceptor of the present invention may include any other layer, in addition to the undercoat layer and the photosensitive layer.

For example, a protective layer may be disposed on the outermost layer of the photoreceptor in order to prevent abrasion of the photosensitive layer or prevent or reduce deterioration of the photosensitive layer, which is caused by discharging materials or the like generated from a charging device or other portions. For example, the protective layer can be made of a suitable binding resin containing an electroconductive material or a copolymer of a charge-transportable compound, such as a triphenylamine skeleton described in Japanese Unexamined Patent Application Publication No. HEI9-190004 or HEI10-252377.

Examples of the electroconductive material can include, but are not limited to, aromatic amino compounds such as TPD (N,N′-diphenyl-N,N′-bis-(m-tolyl)benzidine, and metal oxides such as antimonium oxide, indium oxide, tin oxide, titanium oxide, tin oxide-antimonium oxide, aluminum oxide, and zinc oxide. The electroconductive materials may be used alone or in any combination of two or more kinds in any ratio.

The binder resin used in the protective layer may be any known resin, and examples thereof include polyamide resins, polyurethane resins, polyester resins, epoxy resins, polyketone resins, polycarbonate resins, polyvinyl ketone resins, polystyrene resins, polyacrylamide resins, and siloxane resins. In addition, copolymers of such resins and charge-transportable skeletons, such as a triphenyl amine skeleton described in Japanese Unexamined Patent Application Publication No. HEI9-190004 or HEI10-252377, can be used. These binder resins may be used alone or in any combination of two or more in any ratio.

Furthermore, the protective layer preferably has an electric resistance of 10⁹ to 10¹⁴ Ω·cm. An electric resistance higher than 10¹⁴ Ω·cm may increase the residual potential to form a foggy image. On the other hand, an electric resistance lower than 10⁹ Ω·cm may cause a blur image or a decreased resolution.

In addition, the protective layer must be designed not to prevent from transmitting light for image exposure.

Furthermore, the surface layer may contain, for example, a fluorine resin, a silicone resin, a polyethylene resin, or a polystyrene resin in order to decrease friction resistance and abrasion of the photoreceptor surface and to increase transfer efficiency of toner from the photoreceptor to a transfer belt or paper. The surface layer may also contain particles of these resins or inorganic compounds.

These layers other than the undercoat layer and the photosensitive layer may be formed by any method, but, usually, the layers are formed in series by repeating the coating and drying steps of coating liquids each containing materials constituting each layer by a known coating method, as in the photosensitive layer described above.

### [VI. Advantage of Electrophotographic Photoreceptor of the Present Invention]

The electrophotographic photoreceptor of the present invention exhibits excellent electric characteristics. Specifically, it has high sensitivity and exhibits low residual potential. Furthermore, in general, it exhibits low dark decay.

In addition, image formation with the electrophotographic photoreceptor of the present invention is generally image quality and has an excellent stability of image quality, and in particular, high-quality stable images with less ghosting even without an optical charge elimination process.

### [VII. Image-Forming Apparatus]

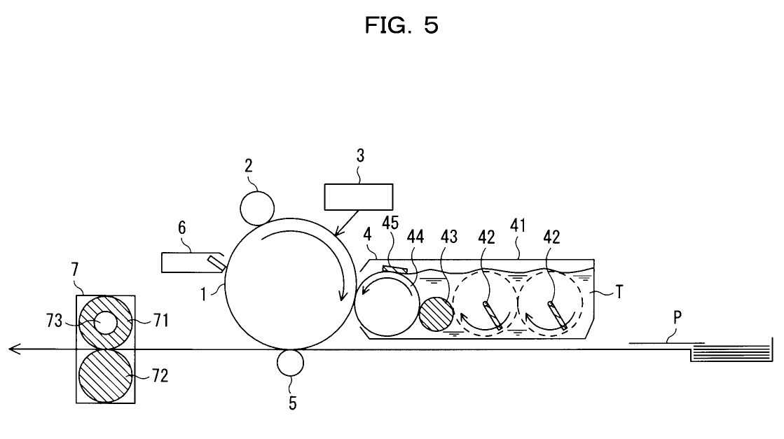

Regarding an embodiment of an image-forming apparatus (image-forming apparatus of the present invention) including the electrophotographic photoreceptor of the present invention, the main structure of the apparatus will now be described with reference to FIG. 5. However, the embodiment is not limited to the following description, and various modifications can be conducted within the scope of the present invention.

As shown in FIG. 5, the image-forming apparatus includes an electrophotographic photoreceptor 1, a charging device (charging means) 2, an exposure device (exposure means; image exposure means) 3, a development device (development means) 4, and a transfer device (transfer means) 5. Furthermore, the image-forming apparatus optionally includes a cleaning device (cleaning means) 6 and a fixation device (fixation means) 7.

The above-described electrophotographic photoreceptor of the present invention is provided as the photoreceptor 1 in the image-forming apparatus of the present invention. That is, in the image-forming apparatus of the present invention including an electrophotographic photoreceptor, charging means for charging the electrophotographic photoreceptor, image exposure means for forming an electrostatic latent image by subjecting the charged electrophotographic photoreceptor to image exposure, development means for developing the electrostatic latent image with toner, and transfer means for transferring the toner to a transfer object, the electrophotographic photoreceptor includes an undercoat layer containing metal oxide particles and a binder resin on an electroconductive support, and a photosensitive layer disposed on the undercoat layer. The metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3. The photosensitive layer contains a compound (arylamine compound according to the present invention) represented by the Formula (I).

The electrophotographic photoreceptor 1 is the above-described electrophotographic photoreceptor of the present invention without any additional requirement. FIG. 5 shows, as such an example, a drum photoreceptor having the above-described photosensitive layer on the surface of a cylindrical electroconductive support. Along the outer surface of this electrophotographic photoreceptor 1, a charging device 2, an exposure device 3, a development device 4, a transfer device 5, and a cleaning device 6 are arranged.

The charging device 2 charges the electrophotographic photoreceptor 1 such that the surface of the electrophotographic photoreceptor 1 is uniformly charged to a predetermined potential. It is preferable that the charging device be in contact with the electrophotographic photoreceptor 1 in order to efficiently utilize the effects of the present invention. FIG. 5 shows a roller charging device (charging roller) as an example of the charging device 2, but other charging devices, for example, corona charging devices such as corotron or scorotron and contacting charging devices such as a charging brush, are widely used.

In many cases, the electrophotographic photoreceptor 1 and the charging device 2 are integrated into a cartridge (hereinafter, optionally, referred to as “photoreceptor cartridge”) that is detachable from the body of an image-forming apparatus. When the electrophotographic photoreceptor 1 or the charging device 2 are degraded, the photoreceptor cartridge can be replaced with a new one by detaching the used photoreceptor cartridge from the image-forming apparatus body and attaching the new one to the image-forming apparatus body. In addition, in many cases, toner described below is also stored in a toner cartridge detachable from an image-forming apparatus body. When the toner in the toner cartridge is exhausted in use, the toner cartridge can be detached from the image-forming apparatus body, and a new toner cartridge can be attached to the apparatus body. Furthermore, a cartridge including all the electrophotographic photoreceptor 1, the charging device 2, and the toner may be used.

The exposure device 3 may be of any type that can form an electrostatic latent image on a photosensitive surface of the electrophotographic photoreceptor 1 by exposure (image exposure) to the electrophotographic photoreceptor 1, and examples thereof include halogen lamps, fluorescent lamps, lasers such as a semiconductor laser and a He—Ne laser, and LEDs (light-emitting diodes). Furthermore, the exposure may be conducted by a photoreceptor internal exposure system. Any light can be used for the exposure. For example, the exposure may be carried out with monochromatic light having a wavelength of 780 nm; monochromatic light having a slightly shorter wavelength of 600 nm to 700 nm; or monochromatic light having a shorter wavelength of 350 nm to 600 nm. Among them, the exposure is preferably carried out with monochromatic light having a short wavelength of 350 nm to 600 nm and more preferably a wavelength of 380 nm to 500 nm.

The development device 4 develops the electrostatic latent image. The development device 4 may be of any type, and examples thereof include dry development systems such as cascade development, one-component conductive toner development, and two-component magnetic brush development; and wet development systems. The development device 4 shown in FIG. 5 includes a development tank 41, agitators 42, a supply roller 43, a development roller 44, a control member 45, and the development tank 41 containing toner T. In addition, the development device 4 may be provided with an optional refill device (not shown) for refilling the toner T. This refill device can refill the development tank 41 with toner T from a container such as a bottle or a cartridge.

The supply roller 43 is made of, for example, an electroconductive sponge. The development roller 44 is, for example, a metal roller made of, e.g., iron, stainless steel, aluminum, or nickel or a resin roller made of such a metal roller coated with, e.g., a silicone resin, an urethane resin, or a fluorine resin. The surface of this development roller 44 may be optionally smoothed or roughened.

The development roller 44 is arranged between the electrophotographic photoreceptor 1 and the supply roller 43 and abuts on both the electrophotographic photoreceptor 1 and the supply roller 43. The supply roller 43 and the development roller 44 are rotated by a rotary drive mechanism (not shown). The supply roller 43 carries the toner T stored and supplies it to the development roller 44. The development roller 44 carries the toner T supplied from the supply roller 43 and brings it into contact with the surface of the electrophotographic photoreceptor 1.

The control member 45 is made of, for example, a resin blade of, e.g., a silicone resin or a urethane resin; a metal blade of, e.g., stainless steel, aluminum, copper, brass, or phosphor bronze; or a blade made of such a metal blade coated with a resin. The control member 45 abuts on the development roller 44 and is biased toward the development roller 44 at a predetermined force (a general blade line pressure is 5 to 500 g/cm) with, for example, a spring. The control member 45 may have an optional function charging the toner T by frictional electrification.

The agitators 42 are each rotated by a rotary drive mechanism and agitate the toner T and transfer it to the supply roller 43. The blade shapes and sizes of the agitators 42 may be different from each other.

The toner T may be of any type, and polymerized toner prepared by suspension polymerization or emulsion polymerization, as well as powder toner, can be used. In particular, in the use of the polymerized toner, a small particle diameter of about 4 to 8 μm is preferred, and various shapes of toner may be used from a spherical shape to a non-spherical shape such as a potato-like shape. The polymerized toner exhibits superior charging uniformity and transferring characteristics and, therefore, can be suitably used for forming an image with higher quality.

The transfer device 5 may be of any type, and devices employing, for example, electrostatic transfer such as corona transfer, roller transfer, or belt transfer; pressure transfer; or adhesive transfer can be used. The transfer device 5 includes a transfer charger, a transfer roller, and a transfer belt that are arranged so as to face the electrophotographic photoreceptor 1. The transfer device 5 transfers a toner image formed in the electrophotographic photoreceptor 1 to a transfer material (transfer object, paper, medium) P by a predetermined voltage (transfer voltage) with a polarity opposite to that of the charged potential of the toner T. In the present invention, it is effective that the transfer device 5 be in contact with the photoreceptor via the transfer material.

The cleaning device 6 may be of any type, and examples thereof include a brush cleaner, a magnetic brush cleaner, an electrostatic brush cleaner, a magnetic roller cleaner, and a blade cleaner. The cleaning device 6 collects remaining toner adhering to the photoreceptor 1 by scraping the remaining toner with a cleaning member. The cleaning device 6 is unnecessary when the amount of toner remaining on the surface of the photoreceptor is small or little.

The fixation device 7 is composed of an upper fixation member (fixation roller) 71 and a lower fixation member (fixation roller) 72, and the fixation member 71 or 72 is provided with a heating device 73 therein. FIG. 5 shows an example of the heating device 73 provided inside the upper fixation member 71. The upper and lower fixation members 71 and 72 may be known thermal fixation members, for example, a fixation roller in which a pipe of a metal material, such as stainless steel or aluminum, is coated with a silicone rubber, a fixation roller further having a fluorine resin coating, or a fixation sheet. In addition, the upper and lower fixation members 71 and 72 may have a structure for supplying a mold-releasing agent, such as a silicone oil, for improving mold release properties or may have a structure for applying a pressure to each other with, for example, a spring.

The toner transferred onto a recording paper P is heated to be melted when passing through between the upper fixation member 71 and the lower fixation member 72 that are heated to a predetermined temperature, and then is fixed on the recording paper P by cooling thereafter.

The fixation device may be of any type, and examples thereof include, in addition to that described here, devices employing a system of heat roller fixation, flash fixation, oven fixation, or pressure fixation.

In the electrophotographic apparatus having a structure described above, an image is recorded as follows: The surface (photosensitive surface) of the photoreceptor 1 is charged to a predetermined potential (for example, −600 V) with the charging device 2. The charging may be conducted by a direct-current voltage or by a direct-current voltage superimposed by an alternating-current voltage.

Subsequently, the charged photosensitive surface of the photoreceptor 1 is exposed with the exposure device 3 depending on the image to be recorded. Thereby, an electrostatic latent image is formed in the photosensitive surface. This electrostatic latent image formed in the photosensitive surface of the photoreceptor 1 is developed by the development device 4.

In the development device 4, the toner T supplied by the supply roller 43 is spread into a thin layer with the control member (developing blade) 45 and, simultaneously, is charged by friction so as to have a predetermined polarity (here, the toner is charged into negative polarity, which is the same as the polarity of the charge potential of the photoreceptor 1). This toner T is held on the development roller 44 and is conveyed and brought into contact with the surface of the photoreceptor 1.

The charged toner T held on the development roller 44 comes into contact with the surface of the photoreceptor 1, so that a toner image corresponding to the electrostatic latent image is formed on the photosensitive surface of the photoreceptor 1. This toner image is transferred to a recording paper P with the transfer device 5. Thereafter, the toner remaining on the photosensitive surface of the photoreceptor 1 without being transferred is removed with the cleaning device 6.

After the transfer of the toner image to the recording paper P, the recording paper P passes through the fixation device 7 to thermally fix the toner image on the recording paper P. Thereby, an image is finally recorded.

The image-forming apparatus may have a structure that can conduct, for example, a charge elimination step, in addition to the above-described structure. The charge elimination step neutralizes the electrophotographic photoreceptor by exposing the electrophotographic photoreceptor with light. Examples of such a device for the charge elimination include fluorescent lamps and LEDs. In many cases, the light used in the charge elimination step has an exposure energy intensity at least 3 times that of the exposure light.

The structure of the image-forming apparatus may be further modified. For example, the image-forming apparatus may have a structure that conducts steps such as a pre-exposure step and a supplementary charging step, that performs offset printing, or that includes a full-color tandem system using plural toners.

In the case that a combination of the photoreceptor 1 and the charging device 2 integrated into a cartridge, it is preferable that the cartridge further include the development device 4. Furthermore, a combination of the photoreceptor 1 and, according to need, one or more of the charging device 2, the exposure device 3, the development device 4, the transfer device 5, the cleaning device 6, and the fixation device 7 may be integrated into an integral cartridge (electrophotographic cartridge) that is detachable from an electrophotographic apparatus such as a copier or a laser beam printer. That is, the electrophotographic cartridge of the present invention includes the electrophotographic photoreceptor and at least one of the charging means for charging the electrophotographic photoreceptor, the image exposure means for forming an electrostatic latent image by conducting image exposure to the charged electrophotographic photoreceptor, the development means for developing the electrostatic latent image with toner, and the transfer means for transferring the toner to a transfer object, wherein the electrophotographic photoreceptor includes an undercoat layer containing metal oxide particles and a binder resin on an electroconductive support, and a photosensitive layer disposed on the undercoat layer. Here, it is preferable that the metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3 and that the photosensitive layer contains a compound (arylamine compound according to the present invention) represented by Formula (I).

In this case, as in the cartridge described in the above embodiment, for example, even if the electrophotographic photoreceptor 1 or another member is deteriorated, the maintenance and check of an image-forming apparatus can be readily performed by detaching the electrophotographic cartridge from the image-forming apparatus body and attaching a new electrophotographic cartridge to the image-forming apparatus body.

The image-forming apparatus and the electrophotographic cartridge of the present invention can form a high-quality image. Specifically, the image-forming apparatus and the electrophotographic cartridge of the present invention is image quality and [SIC] has an excellent stability of image quality, in particular, in the case without an optical charge elimination process.

Furthermore, in the conventional case that a transfer device 5 is provided in contact with a photoreceptor via a transfer material, the quality of an image is readily deteriorated. However, the image-forming apparatus and the electrophotographic cartridge of the present invention hardly cause such quality deterioration and are hence effective.

### EXAMPLES

The present invention will now be further specifically described with reference to Examples and Comparative Examples, but is not limited thereto within the scope of the present invention. In the description of Examples, the term “part(s)” means “part(s) by weight” unless otherwise specified.

### Example 1

### Coating Liquid for a Undercoat Layer

Surface-treated titanium oxide was prepared by mixing rutile titanium oxide having an average primary particle diameter of 40 nm (“TTO55N”, manufactured by Ishihara Sangyo Co., Ltd.) and methyldimethoxysilane (“TSL8117”, manufactured by Toshiba Silicone Co., Ltd.) in an amount of 3 weight % on the basis of the amount of the titanium oxide with a Henschel mixer. 1 kg of raw material slurry composed of a mixture of 50 parts of the surface-treated titanium oxide and 120 parts of methanol was subjected to dispersion treatment for 1 hour using zirconia beads with a diameter of about 100 μm (YTZ, manufactured by Nikkato Corp.) as a dispersion medium and an Ultra Apex Mill (model UAM-015, manufactured by Kotobuki Industries Co., Ltd.) having a mill capacity of about 0.15 L under liquid circulation conditions of a rotor peripheral velocity of 10 m/second and a liquid flow rate of 10 kg/hour to give a titanium oxide dispersion.

The titanium oxide dispersion, a solvent mixture of methanol/1-propanol/toluene, and a pelletized copolymerized polyamide composed of ε-caprolactam [compound represented by the following Formula (A)]/bis(4-amino-3-methylcyclohexyl)methane [compound represented by the following Formula (B)]/hexamethylene diamine [compound represented by the following Formula (C)]/decamethylenedicarboxylic acid [compound represented by the following Formula (D)]/octadecamethylenedicarboxylic acid [compound represented by the following Formula (E)] at a molar ratio of 60%/15%/5%/15%/5% were mixed with agitation under heat to dissolve the pelletized polyamide. The resulting solution was subjected to ultrasonic dispersion treatment for 1 hour with an ultrasonic oscillator at an output of 1200 W and then filtered through a PTFE membrane filter with a pore size of 5 μm (Mitex LC, manufactured by Advantech Co., Ltd.) to give a coating liquid A for forming an undercoat layer wherein the weight ratio of the surface-treated titanium oxide/copolymerized polyamide was 3/1, the weight ratio of methanol/1-propanol/toluene in the solvent mixture was 7/1/2, and the solid content was 18.0 weight %.

The particle size distribution of this coating liquid A for forming an undercoat layer measured using the above-mentioned UPA is shown in Table 2.

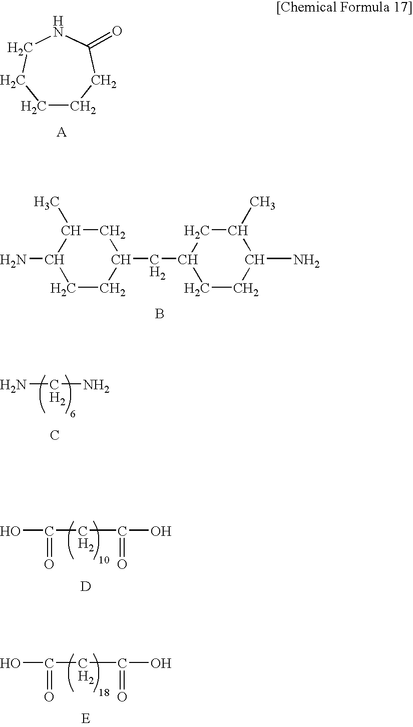

This coating liquid A for forming an undercoat layer was applied to a non-anodized aluminum cylinder (outer diameter: 30 mm, length: 351 mm, thickness: 1.0 mm) by dipping to form an undercoat layer with a dried thickness of 1.5 μm.

This undercoat layer (94.2 cm²) was immersed in a solvent mixture of 70 g of methanol and 30 g of 1-propanol and was sonicated with an ultrasonic oscillator at an output of 600 W for 5 minutes to prepare an undercoat layer dispersion. The particle size distribution of the metal oxide particles in the dispersion was measured with the UPA. The volume average particle diameter was 0.09 μm, and the 90% cumulative particle diameter was 0.12 μm.

Then, as a charge-generating material, 20 parts of D-type oxytitanium phthalocyanine and 280 parts of 1,2-dimethoxyethane were mixed and pulverized in a sand grind mill for 2 hours for microparticle dispersion treatment.

Then, this microparticle treatment liquid was mixed with a binder solution prepared by dissolving polyvinyl butyral (trade name “Denka Butyral” #6000C, manufactured by Denki Kagaku Kogyo K.K.) in a solvent mixture of 253 parts of 1,2-dimethoxyethane and 85 parts of 4-methoxy-4-methyl-2-pentanone, and 230 parts of 1,2-dimethoxyethane to prepare a dispersion (charge-generator).

This dispersion (charge generator) was applied to the aluminum cylinder provided with the undercoat layer by dipping to form a charge-generating layer having a dried thickness of 0.3 μm (0.3 g/m²).

Then, 50 parts of a charge-transporting material represented by the following compound (CT-1):

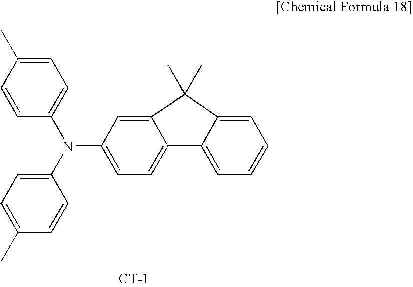

100 parts of a binder resin of polycarbonate having a repeating unit represented by the following structure (PC1, viscosity-average molecular weight: about 30000, m:n=1:1):

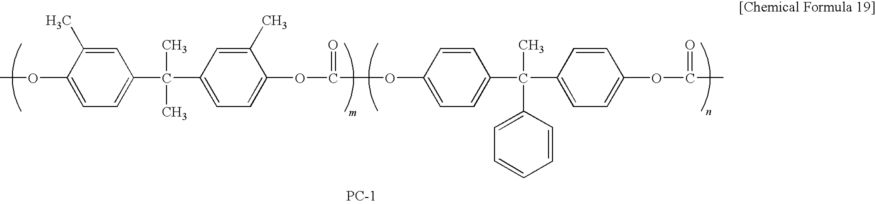

8 parts of antioxidant having the following structure:

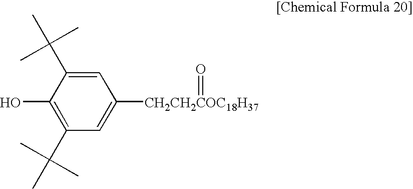

and 0.05 part of a silicone oil leveling agent (trade name: KF96, manufactured by Shin-Etsu Chemical Co., Ltd.) were dissolved in 640 parts of a solvent mixture of tetrahydrofuran/toluene (weight ratio: 8/2). The resulting solution was applied onto the charge-generating layer by dipping to form a layer with a dried thickness of 18 μm to give a photoreceptor drum E1 having a laminated photosensitive layer.

The photosensitive layer (94.2 cm²) of the resulting photoreceptor E1 was removed by dissolving the layer in 100 of tetrahydrofuran by sonication with an ultrasonic oscillator at an output of 600 W for 5 minutes, and then the same area of photoreceptor E1 subjected to the sonication treatment was immersed in a solvent mixture of 70 g of methanol and 30 g of 1-propanol and was sonicated with an ultrasonic oscillator at an output of 600 W for 5 minutes to give an undercoat layer dispersion. The particle size distribution of the metal oxide particles in the dispersion was measured with the UPA. The volume average particle diameter was 0.08 μm, and the 90% cumulative particle diameter was 0.11 μm.

### Example 2

A photoreceptor E2 was produced as in Example 1 except that the following compound (CT-2) was used as the charge-transporting material, instead of the compound (CT-1).

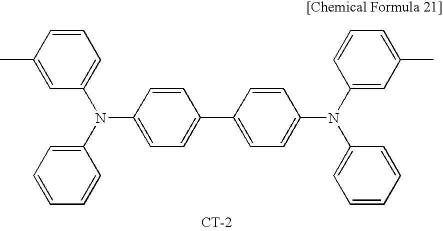

### Example 3

A photoreceptor E3 was produced as in Example 1 except that the following compound (CT-3) was used as the charge-transporting material, instead of the compound (CT-1).

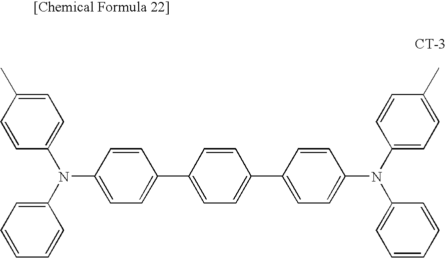

### Example 4

A photoreceptor E4 was produced as in Example 1 except that the following compound (CT-4) was used as the charge-transporting material, instead of the compound (CT-1).

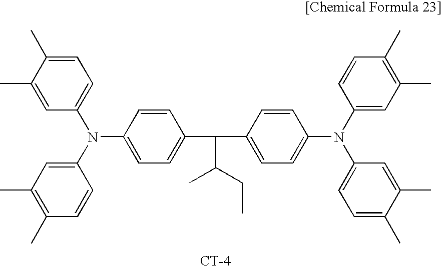

### Example 5

A coating liquid B for forming an undercoat layer was prepared as in Example 1 except that the dispersion medium used for dispersion in the Ultra Apex Mill was zirconia beads having a diameter of about 50 μm (YTZ, manufactured by Nikkato Corp.), and the physical properties thereof were measured as in Example 1. The results are shown in Table 2.

The coating liquid B for forming an undercoat layer was applied to a non-anodized aluminum cylinder (outer diameter: 30 mm, length: 351 mm, thickness: 1.0 mm) by dipping to form an undercoat layer with a dried thickness of 1.5 μm.

This undercoat layer (94.2 cm²) was immersed in a solvent mixture of 70 g of methanol and 30 g of 1-propanol and was sonicated with an ultrasonic oscillator at an output of 600 W for 5 minutes to prepare an undercoat layer dispersion. The particle size distribution of the metal oxide particles in this dispersion was measured with the UPA as in Example 1. The volume average particle diameter was 0.08 μm, and the 90% cumulative particle diameter was 0.12 μm.

A charge-generating layer and a charge-transporting layer were formed on the resulting undercoat layer as in Example 1 to give a photoreceptor E5.

The photosensitive layer (94.2 cm²) of the resulting photoreceptor E5 was removed by dissolving the layer in 100 cm³ of tetrahydrofuran by sonication with an ultrasonic oscillator at an output of 600 W for 5 minutes, and then the photoreceptor E5 subjected to the sonication treatment was immersed in a solvent mixture of 70 g of methanol and 30 g of 1-propanol and was sonicated with an ultrasonic oscillator at an output of 600 W for 5 minutes to give an undercoat layer dispersion. The particle size distribution of the metal oxide particles in the dispersion was measured with the UPA as in Example 1. The volume average particle diameter was 0.08 μm, and the 90% cumulative particle diameter was 0.12 μm.

### Example 6

A coating liquid C for forming an undercoat layer was prepared as in Example 6 except that the rotor peripheral velocity of the Ultra Apex Mill was 12 m/second, and physical properties thereof were measured as in Example 1. The results are shown in Table 2.

Using this coating liquid C for forming an undercoat layer, an undercoat layer was formed on an aluminum cylinder by dipping as in Example 1.

This undercoat layer (94.2 cm²) was immersed in a solvent mixture of 70 g of methanol and 30 g of 1-propanol and was sonicated with an ultrasonic oscillator at an output of 600 W for 5 minutes to give an undercoat layer dispersion. The particle size distribution of the metal oxide particles in the dispersion was measured with the UPA as in Example 1. The volume average particle diameter was 0.08 μm, and the 90% cumulative particle diameter was 0.11 μm.

Then, a photoreceptor E6 was produced as in Example 1 except that the coating liquid C for forming an undercoat layer was used.

The photosensitive layer (94.2 cm²) of the resulting photoreceptor E6 was removed by dissolving the layer in 100 cm³ of tetrahydrofuran by sonication with an ultrasonic oscillator at an output of 600 W for 5 minutes, and then the photoreceptor E6 subjected to the sonication treatment was immersed in a solvent mixture of 70 g of methanol and 30 g of 1-propanol and was sonicated with an ultrasonic oscillator at an output of 600 W for 5 minutes to give an undercoat layer dispersion. The particle size distribution of the metal oxide particles in the dispersion was measured with the UPA as in Example 1. The volume average particle diameter was 0.08 μm, and the 90% cumulative particle diameter was 0.11 μm.

### Comparative Example 1

A photoreceptor P1 was produced as in Example 1 except that the following compound (CT-5) was used as the charge-transporting material, instead of the compound (CT-1).

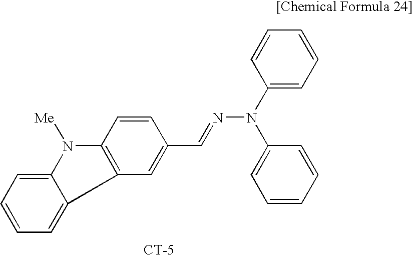

### Comparative Example 2

A photoreceptor P2 was produced as in Example 1 except that the following compound (CT-6) was used as the charge-transporting material, instead of the compound (CT-1).

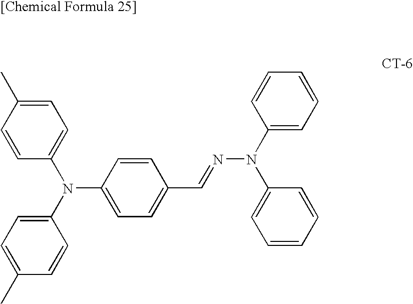

### Comparative Example 3

Rutile titanium oxide having an average primary particle diameter of 40 nm (“TTO55N”, manufactured by Ishihara Sangyo Co., Ltd.) and methyldimethoxysilane in an amount of 3 weight % on the basis of the amount of the titanium oxide were mixed in a ball mill to prepare slurry. After the slurry was dried, the residue was washed with methanol and dried to yield hydrophobic-treated titanium oxide. This hydrophobic-treated titanium oxide was dispersed in a mixture solvent of methanol/1-propanol in a ball mill to give dispersion slurry of hydrophobic-treated titanium oxide. This dispersion slurry, a solvent mixture of methanol/1-propanol/toluene (weight ratio: 7/1/2), and a pelletized copolymerized polyamide composed of ε-caprolactam/bis(4-amino-3-methylcyclohexyl)methane/hexamethylene diamine/decamethylenedicarboxylic acid/octadecamethylenedicarboxylic acid (composed molar %: 60/15/5/15/5) were mixed with agitation under heat, thereby dissolving the pelletized polyamide. The resulting solution was subjected to ultrasonic dispersion treatment to give a coating liquid D for forming an undercoat layer containing the hydrophobic-treated titanium oxide/copolymerized polyamide at a weight ratio of 3/1 and having a solid content of 18.0%.

An undercoat layer was formed on an aluminum cylinder by dip coating as in Example 1 using this coating liquid D for forming an undercoat layer.

This undercoat layer (94.2 cm²) was immersed in a solvent mixture of 70 g of methanol and 30 g of 1-propanol and was sonicated with an ultrasonic oscillator at an output of 600 W for 5 minutes to give an undercoat layer dispersion. The particle size distribution of the metal oxide particles in the dispersion was measured with the UPA as in Example 1. The volume average particle diameter was 0.11 μm, and the 90% cumulative particle diameter was 0.20 μm.

A photoreceptor P3 was produced as in Example 1 except that the coating liquid D for forming an undercoat layer was used.

The photosensitive layer (94.2 cm²) of the resulting photoreceptor P3 was removed by dissolving the layer in 100 cm³ of tetrahydrofuran by sonication with an ultrasonic oscillator at an output of 600 W for 5 minutes, and then the photoreceptor P3 subjected to the sonication treatment was immersed in a solvent mixture of 70 g of methanol and 30 g of 1-propanol and was sonicated with an ultrasonic oscillator at an output of 600 W for 5 minutes to give an undercoat layer dispersion. The particle size distribution of the metal oxide particles in the dispersion was measured with the UPA as in Example 1. The volume average particle diameter was 0.11 μm, and the 90% cumulative particle diameter was 0.18 μm.

### Comparative Example 4

A photoreceptor P4 was produced as in Comparative Example 3 except that the following compound (CT-2) was used as the charge-transporting material, instead of the compound (CT-1).

### [Evaluation of Electric Characteristics]

The electrophotographic photoreceptors produced in Examples and Comparative Example were mounted on an electrophotographic characteristic evaluation device produced according to a standard of The Society of Electrophotography of Japan (Zoku Denshi Shashin Gizyutsu no Kiso to Oyo (Fundamentals and Applications of Electrophotography II) edited by The Society of Electrophotography of Japan, published by Corona Publishing Co., Ltd., pp. 404-405) and subjected to evaluation of electric characteristics through the following cycle of charging (negative polarity), exposure, potential measurement, and charge elimination.

The photoreceptor was charged such that the initial surface potential was −700 V and then was irradiated with monochromatic light of 780 nm, which emitted from a halogen lamp and was monochromatized through an interference filter. The irradiation energy (half-decay exposure energy) required when the surface potential reaches −350 V was measured (μJ/cm²) as sensitivity (E1/2). In addition, the surface potential (VL1) after 100 ms of the irradiation with exposure light having an intensity of 1.0 μJ/cm² was measured (−V). Furthermore, the photoreceptor was charged to an initial surface potential of −700 V, and after leaving in a dark place for 5 seconds, the surface potential was measured. The difference was used as the dark decay (DD). These results are shown in Table 3.

In the column “undercoat layer” of Table 3 (and Tables 4 and 5 shown below), “α” represents the coating liquid A, B, or C for forming an undercoat layer, and “β” represents the coating liquid D for forming an undercoat layer.

TABLE 2

| | | Volume average | 90% cumulative |
|---|---|---|---|
| | Coating | particle | particle |
| | liquid | diameter (μm) | diameter (μm) |
| Example 1 | A | 0.09 | 0.13 |
| Example 5 | B | 0.08 | 0.12 |
| Example 6 | C | 0.08 | 0.11 |
| Comparative Example 3 | D | 0.13 | 0.20 |

TABLE 3

| | | Specification of | | | | |
|---|---|---|---|---|---|---|
| | | photoreceptor | | Electric Characteristics | | |
| | | Charge- | Under- | E½ | | |
| | Photo- | transporting | coat | (uJ/cm²) | VL1 | DD |
| | receptor | material | layer | [SIC] | (−V) | (V) |
| Example 1 | E1 | CT-1 | α | 0.096 | 68 | 35 |
| Example 2 | E2 | CT-2 | α | 0.094 | 63 | 38 |
| Example 3 | E3 | CT-3 | α | 0.094 | 49 | 36 |
| Example 4 | E4 | CT-4 | α | 0.098 | 46 | 33 |
| Example 5 | E5 | CT-1 | α | 0.095 | 67 | 35 |
| Example 6 | E6 | CT-1 | α | 0.096 | 69 | 34 |
| Comparative | P1 | CT-5 | α | 0.128 | 138 | 52 |
| Example 1 | | | | | | |
| Comparative | P2 | CT-6 | α | 0.095 | 46 | 51 |
| Example 2 | | | | | | |
| Comparative | P3 | CT-1 | β | 0.098 | 73 | 44 |
| Example 3 | | | | | | |
| Comparative | P4 | CT-2 | β | 0.098 | 54 | 46 |
| Example 4 | | | | | | |

### [Image Evaluation Test I]

Each of the electrophotographic photoreceptors produced in Examples 1 to 6 and Comparative Examples 1 to 4 were mounted on a cyan drum cartridge (integrated cartridge including a contact-type charging roller member, a blade cleaning member, and a development member) of a commercially available tandem-type color printer (Microline 3050c, manufactured by Oki Data Corp.) with no optical charge elimination process, compatible with A3 printing, and then the cartridge was loaded on the printer.

A pattern having boldface characters in white on the upper area of an A3 region and a halftone portion from the central area to the lower area of the A3 region was sent as an input of printing data from a personal computer to the printer. The resulting output image was visually evaluated.

Since the printer used for the evaluation has no charge elimination process, the characters in the upper area of the pattern may be memorized on the photoreceptor and adversely affect the image formation in the next rotation, depending on the performance of a photoreceptor. That is, ghost characters may appear in the halftone portion. The degree of appearance of the ghosting in an area that should be essentially solid was classified into five ranks. Here, rank 1 denotes the most satisfactory result, and rank 5 denotes the strongest ghosting result. The results are shown in Table 4.

TABLE 4

| | | Specification of photoreceptor | | |
|---|---|---|---|---|
| | | Charge- | | Image |
| | Photo- | generating | Undercoat | characteristics |
| | receptor | material | layer | Ghosting level |
| Example 1 | E1 | CT-1 | α | 2 |
| Example 2 | E2 | CT-2 | α | 2 |
| Example 3 | E3 | CT-3 | α | 3 |
| Example 4 | E4 | CT-3 | α | 1 |
| Example 5 | E5 | CT-1 | α | 2 |
| Example 6 | E6 | CT-1 | α | 2 |
| Comparative | P1 | CT-5 | α | 5 |
| Example 1 | | | | |
| Comparative | P2 | CT-6 | α | 4 |
| Example 2 | | | | |
| Comparative | P3 | CT-1 | β | 3 |
| Example 3 | | | | |
| Comparative | P4 | CT-2 | β | 3 |
| Example 4 | | | | |

As obvious from the results shown above, the photoreceptors of the present invention exhibit excellent electric characteristics and reduced ghosting.

### Example 7

A photoreceptor E7 was produced as in Example 1 except that an aluminum cylinder on which a photosensitive layer was formed had an outer diameter of 24 mm, a length of 246 mm, and a thickness of 0.75 mm.

### Example 8

A photoreceptor E8 was produced as in Example 2 except that an aluminum cylinder on which a photosensitive layer was formed had an outer diameter of 24 mm, a length of 246 mm, and a thickness of 0.75 mm.

### Example 9

A photoreceptor E9 was produced as in Example 3 except that an aluminum cylinder on which a photosensitive layer was formed had an outer diameter of 24 mm, a length of 246 mm, and a thickness of 0.75 mm.

### Example 10

A photoreceptor E10 was produced as in Example 4 except that an aluminum cylinder on which a photosensitive layer was formed had an outer diameter of 24 mm, a length of 246 mm, and a thickness of 0.75 mm.

### Comparative Example 5

A photoreceptor P5 was produced as in Comparative Example 1 except that an aluminum cylinder on which a photosensitive layer was formed had an outer diameter of 24 mm, a length of 246 mm, and a thickness of 0.75 mm.

### Comparative Example 6

A photoreceptor P6 was produced as in Comparative Example 2 except that an aluminum cylinder on which a photosensitive layer was formed had an outer diameter of 24 mm, a length of 246 mm, and a thickness of 0.75 mm.

### Comparative Example 7

A photoreceptor P7 was produced as in Comparative Example 3 except that an aluminum cylinder on which a photosensitive layer was formed had an outer diameter of 24 mm, a length of 246 mm, and a thickness of 0.75 mm.

### Comparative Example 8

A photoreceptor P8 was produced as in Comparative Example 4 except that an aluminum cylinder on which a photosensitive layer was formed had an outer diameter of 24 mm, a length of 246 mm, and a thickness of 0.75 mm.

### [Image Evaluation Test II]

The electrophotographic photoreceptors produced in Examples 7 to 10 and Comparative Examples 5 to 8 were mounted on a cartridge (integrated cartridge including a contact-type charging roller member, a blade cleaning member, and a development member) of a commercially available monochrome printer (LaserJet 1100, manufactured by Hewlett Packard) with no optical charge elimination process, compatible with A4 printing, and then the cartridge was loaded on the printer.

It was set to output an A4 image where a solid black image and a solid white portion lie in a part (about 75 mm) corresponding to a first turn of the electrophotographic photoreceptor, and a halftone portion lies in a second turn or later. Surface potentials of the electrophotographic photoreceptor at the halftone image portion of the second turn were measured at the beginning and after continuous printing of 1000 copies, and, in the halftone image portion of the second turn, potentials at the portion corresponding to the solid black portion of the first turn and at the portion corresponding to the solid white portion of the first turn were measured. A larger potential difference means significant ghosting. The results are shown in Table 5.

TABLE 5

| | | | | Ghosting | |
|---|---|---|---|---|---|
| | | Specification of | | (potential difference) | |
| | | photoreceptor | | Initial | Potential |
| | | Charge- | Under- | potential | difference |
| | Photo- | generating | coat | difference | (V) after 1000 |
| | receptor | material | layer | (V) | copies printing |
| Example 7 | E7 | CT-1 | α | 2 | 5 |
| Example 8 | E8 | CT-2 | α | 3 | 5 |
| Example 9 | E9 | CT-3 | α | 5 | 9 |
| Example 10 | E10 | CT-3 | α | 1 | 4 |
| Comparative | P5 | CT-5 | α | 18 | 34 |
| Example 5 | | | | | |
| Comparative | P6 | CT-6 | α | 13 | 21 |
| Example 6 | | | | | |
| Comparative | P7 | CT-1 | β | 4 | 18 |
| Example 7 | | | | | |
| Comparative | P8 | CT-2 | β | 6 | 20 |
| Example 8 | | | | | |

The results shown in Table 5 evidentially demonstrate that use of the photoreceptor of the present invention can suppress the potential difference in both at the initial stage and after repeated use, thereby suppressing ghosting.

### INDUSTRIAL APPLICABILITY

The present invention can be applied to any industrial field, in particular, can be preferably applied to, for example, printers, facsimile machines, and copiers of electrophotographic systems.

Although the present invention has been described in detail with reference to certain preferred embodiments, those skilled in the art will recognize that various modifications will be made without departing from the purpose and scope of the present invention.

The present application is based on Japanese Patent Application (Patent Application No. 2006-139530) filed on May 18, 2006, the entire content of which is hereby incorporated by reference.

1. An electrophotographic photoreceptor, comprising
an undercoat layer containing metal oxide particles and a binder resin on an electroconductive support, and a photosensitive layer disposed on the undercoat layer, wherein
the metal oxide particles have a volume average particle diameter of 0.1 μm or less and a 90% cumulative particle diameter of 0.3 μm or less which are measured by a dynamic light-scattering method in a liquid containing the undercoat layer material dissolved and dispersed from its electroconductive support in a solvent mixture of methanol and 1-propanol at a weight ratio of 7:3; and
the photosensitive layer contains a compound represented by the following Formula (I): 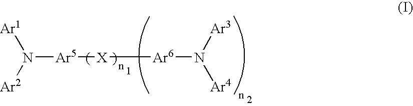
wherein Ar¹ to Ar⁶ each independently represent represents an aromatic moiety that may have a substituent; X represents an organic moiety that may have a substituent; and n₁ and n₂ each independently represent an integer of 0 to 2.

2. The electrophotographic photoreceptor according to claim 1, wherein Ar¹ is a fluorenyl group.

3. The electrophotographic photoreceptor according to claim 1, wherein X represents a phenylene group.

4. The electrophotographic photoreceptor according to claim 1, wherein, in Formula (I), n₂ is 1, and X represents an alkylidene group that may have a substituent.

5. An image-forming apparatus, comprising:
an electrophotographic photoreceptor according to claim 1;
charging means for charging the electrophotographic photoreceptor;
image exposing means for forming an electrostatic latent image by conducting image exposure on the charged electrophotographic photoreceptor;
development means for developing the electrostatic latent image with toner; and
transfer means for transferring the toner to a transfer object.

6. An electrophotographic cartridge comprising:
an electrophotographic photoreceptor according to claim 1; and
at least one of charging means for charging the electrophotographic photoreceptor, image exposing means for forming an electrostatic latent image by conducting image exposure of the charged electrophotographic photoreceptor, development means for developing the electrostatic latent image with toner, and transfer means for transferring the toner to a transfer object.
